(19) United States
(12) Patent Application Publication
(10) Pub. No.: US 2026/0177416 A1
(43) Pub. Date: Jun. 25, 2026

(54) METHOD FOR TRANSFERRING POWDER SAMPLE AND RELATED PRODUCTES

(71) Applicant: SHENZHEN JINGTAI TECHNOLOGY CO., LTD., Shenzhen (CN)

(72) Inventors: Yang LIU, Shenzhen (CN); Yingtan HUANG, Shenzhen (CN); Yijun LI, Shenzhen (CN)

(21) Appl. No.: 19/434,604

(22) Filed: Dec. 29, 2025

Related U.S. Application Data
(63) Continuation of application No. PCT/CN2025/103952, filed on Jun. 26, 2025.

(30) Foreign Application Priority Data
Dec. 19, 2024 (CN) 202411900259.1
Dec. 19, 2024 (CN) 202411900346.7

(51) Int. Cl. G01G 13/02; B01J 8/00; G01G 13/295; G01G 13/32; G05D 5/00

(52) U.S. Cl. CPC G01G 13/026; B01J 8/002; G01G 13/295; G01G 13/32; G05D 5/00; B01J 2208/00619; B01J 2208/00654; B01J 2208/00752

(57) ABSTRACT

A method for transferring a powder sample and related products are provided. The method includes the following. A powder-scooping-and-transferring apparatus is controlled to perform a powder-scooping operation at a source container. A first weight m1 recorded by a weighing apparatus is acquired in a case where a container base is in contact with the weighing apparatus, after the powder-scooping operation is completed. The powder-scooping-and-transferring apparatus is controlled to perform a powder-dropping operation at a target container. A third weight m3 recorded by the weighing apparatus is acquired in a case where the container base is in contact with the weighing apparatus, after the powder-dropping operation is completed. A transferred-powder amount ma is acquired according to the third weight m3 and the first weight m1, where ma=m3−m1.

### CROSS-REFERENCE TO RELATED APPLICATION(S)

This application is a continuation of International Application PCT/CN2025/103952, filed on Jun. 26, 2025, which claims priority to Chinese Patent Application No. 202411900259.1 filed Dec. 19, 2024, and Chinese Patent Application No. 202411900346.7 filed Dec. 19, 2024, which are hereby incorporated by reference in the entire disclosures.

### TECHNICAL FIELD

This disclosure relates to the field of sample dispensing technology, and in particular, to a method for transferring a powder sample and related products.

### BACKGROUND

In fields of chemical synthesis, high-throughput screening, food monitoring, environmental monitoring, etc., powder dispensing or powder sample preparation is often required, with a wide range of application scenarios. In the conventional manual dispensing method, a target container is placed on a balance, an experimenter uses a small spoon to scoop powder from a source container and then drop scooped-powder into the target container, and the balance weighs dropped-powder.

### SUMMARY

In a first aspect of embodiments of the disclosure, a method for transferring a powder sample is provided. The method is applicable to a powder-scooping system. The powder-scooping system includes a weighing apparatus, a container base, and a powder-scooping-and-transferring apparatus. The container base is configured to place a source container and a target container. The weighing apparatus is located below the container base and is configured to weigh the container base in a case where the weighing apparatus is in contact with the container base. The powder-scooping-and-transferring apparatus is configured to scoop powder from the source container and transfer scooped powder to the target container. The method includes the following. The powder-scooping-and-transferring apparatus is controlled to perform a powder-scooping operation at the source container. A first weight m1 recorded by the weighing apparatus is acquired in a case where the container base is in contact with the weighing apparatus, after the powder-scooping operation is completed. The powder-scooping-and-transferring apparatus is controlled to perform a powder-dropping operation at the target container. A third weight m3 recorded by the weighing apparatus is acquired in a case where the container base is in contact with the weighing apparatus, after the powder-dropping operation is completed. A transferred-powder amount ma is acquired according to the third weight m3 and the first weight m1, where ma=m3−m1.

In a second aspect of embodiments of the disclosure, a sample-transferring device is provided. The sample-transferring device includes a processor and a memory. The memory is configured to store computer programs. The computer programs include program instructions. The processor is configured to run the program instructions to control a powder-scooping system to perform the following operations. The powder-scooping system includes a weighing apparatus, a container base, and a powder-scooping-and-transferring apparatus. The container base is configured to place a source container and a target container. The weighing apparatus is located below the container base and is configured to weigh the container base in a case where the weighing apparatus is in contact with the container base. The powder-scooping-and-transferring apparatus is configured to scoop powder from the source container and transfer scooped powder to the target container. The operations include the following. The powder-scooping-and-transferring apparatus is controlled to perform a powder-scooping operation at the source container. A first weight m1 recorded by the weighing apparatus is acquired in a case where the container base is in contact with the weighing apparatus, after the powder-scooping operation is completed. The powder-scooping-and-transferring apparatus is controlled to perform a powder-dropping operation at the target container. A third weight m3 recorded by the weighing apparatus is acquired in a case where the container base is in contact with the weighing apparatus, after the powder-dropping operation is completed. A transferred-powder amount ma is acquired according to the third weight m3 and the first weight m1, where ma=m3−m1.

In a third aspect of embodiments of the disclosure, a non-transitory computer-readable storage medium is provided. The non-transitory computer-readable storage medium is configured to store computer programs for electronic data interchange (EDI). The computer programs include program instructions which, when executed by a processor, cause the processor to execute the following. A powder-scooping-and-transferring apparatus is controlled to perform a powder-scooping operation at a source container. A first weight m1 recorded by a weighing apparatus is acquired in a case where a container base is in contact with the weighing apparatus, after the powder-scooping operation is completed. The powder-scooping-and-transferring apparatus is controlled to perform a powder-dropping operation at a target container. A third weight m3 recorded by the weighing apparatus is acquired in a case where the container base is in contact with the weighing apparatus, after the powder-dropping operation is completed. A transferred-powder amount ma is acquired according to the third weight m3 and the first weight m1, where ma=m3−m1.

### BRIEF DESCRIPTION OF THE DRAWINGS

To illustrate technical solutions in embodiments of the disclosure or the related art more clearly, the accompanying drawings required for describing the embodiments or the related art are briefly introduced below. Obviously, the accompanying drawings in the following description are merely for some embodiments of the disclosure. For those of ordinary skill in the art, other accompanying drawings can also be acquired based on these drawings without creative efforts.

FIG. 1 is a schematic structural diagram of a powder-scooping system provided in embodiments of the disclosure.

FIG. 2 is a schematic structural diagram of another powder-scooping system provided in embodiments of the disclosure.

FIG. 3 is a schematic flow chart of a method for transferring a powder sample provided in embodiments of the disclosure.

FIG. 4 is a schematic flow chart of another method for transferring the powder sample provided in embodiments of the disclosure.

FIG. 5 is a schematic flow chart of another method for transferring the powder sample provided in embodiments of the disclosure.

FIG. 6 is a schematic flow chart of another method for transferring the powder sample provided in embodiments of the disclosure.

FIG. 7 is a schematic flow chart of another method for transferring the powder sample provided in embodiments of the disclosure.

FIG. 8 is a schematic flow chart of another method for transferring the powder sample provided in embodiments of the disclosure.

FIG. 9 is a schematic flow chart of another method for transferring the powder sample provided in embodiments of the disclosure.

FIG. 10 is a schematic flow chart of another method for transferring the powder sample provided in embodiments of the disclosure.

FIG. 11 is a schematic flow chart of yet another method for transferring the powder sample provided in embodiments of the disclosure.

FIG. 12 is a schematic structural diagram of a powder-sample-transferring apparatus provided in embodiments of the disclosure.

FIG. 13 is a schematic structural diagram of a sample-transferring device provided in embodiments of the disclosure.

### DETAILED DESCRIPTION

The technical solutions for embodiments of the disclosure are clearly and completely described with reference to the accompanying drawings in embodiments of the disclosure. Obviously, the described embodiments are merely some rather than all of the embodiments of the disclosure. All other embodiments acquired by those of ordinary skill in the art without creative efforts based on the embodiments in the disclosure shall fall within the protection scope of the disclosure.

The terms “first”, “second”, and the like in the specification and claims of the disclosure and the accompanying drawings are used for distinguishing different objects, rather than for describing a specific order. Furthermore, the terms “include” and “have” and any variations thereof are intended to cover non-exclusive inclusions. For example, a process, method, system, product or apparatus that includes a series of operations or units is not limited to the listed operations or units, but optionally further includes operations or units not listed, or optionally further includes other operations or units inherent to the process, method, product, or apparatus. The term “and/or” used herein includes any and all combinations of one or more related listed items. The term “at least one of A or B” used herein refers to A alone, B alone, or both A and B. For example, “A, B, and/or C” means “any one of: A; B; C; A and B; A and C; B and C; A, B, and C”; and “at least one of A, B, or C” means “any one of: A; B; C; A and B; A and C; B and C; A, B, and C”. An exception to this definition will only occur when the combination of elements, functions, steps, or operations is inherently mutually exclusive in some way.

Reference in the disclosure to “embodiment” means that a particular feature, structure, or property described in connection with the embodiment may be included in at least one embodiment of the disclosure. The appearances of this phrase in various places in the description are not necessarily all referring to the same embodiment, nor are separate or alternative embodiments mutually exclusive of other embodiments. It can be explicitly and implicitly understood by those of ordinary skill in the art that the embodiments described herein can be combined with other embodiments.

The sample-transferring device involved in the embodiments of the disclosure is a device with data processing capabilities and computing capabilities. It can be a mobile phone, a tablet computer, a notebook computer, an ultra-mobile personal computer (UMPC), a netbook, a digital signal processor, a microcontroller unit (MCU), etc.

The following are explanations for terms involved in embodiments of the disclosure.
(1) Scoop: a precise instrument used to accurately scoop for a certain amount of powder. It is a metal tool with a spoon-shaped recess at one end and a long handle.
(2) Container base: an apparatus in a powder-scooping system, used to place a source container containing powder and a target container.
(3) Vessel holder: a combination of apparatuses in the powder-scooping system, used to hold the container base, a balance, and a balance cover.
(4) Technique: a set of movement trajectories of the scoop that can achieve specific powder-scooping-related effects.
(5) Shake: a way of vibrating the scoop up, down, left, and right when the scoop is at different angles.
(6) Weight increment method: a method of calculating an actual dropped-powder amount after the powder is dropped into the target container, through continuously acquiring readings of the balance.
(7) Weight reduction method: a method of calculating an actual scooped-powder amount after the powder is scooped and the shaking is performed, through continuously acquiring readings of the balance.

In experimental scenarios of chemical synthesis, high-throughput screening, food monitoring, environmental monitoring, etc., powder dispensing or powder sample preparation is often required, with a wide range of application scenarios. In the traditional manual dispensing method, a target container is placed on a balance, an experimenter uses a small spoon to scoop powder from a source container and then drop scooped-powder into the target container, and the balance weighs dropped-powder. The method has the following drawbacks.
(1) Multiple operations of powder-scooping and powder-dropping are required, which consumes a lot of time and efforts of the experimenter, resulting in high labor cost and low efficiency.
(2) Manual operations are prone to errors, which affects the weighing accuracy.
(3) Powder long-time-exposed to open environment is susceptible to be moisturized, oxidized, or contaminated, which affects properties of the powder.
(4) Volatilized gas from powder being toxic or harmful materials may have a certain impact on human health.

The method for transferring a powder sample in embodiments of the disclosure can control a powder-scooping-and-transferring apparatus to perform a powder-scooping operation at the source container, to perform a powder-dropping operation to transfer scooped powder from the source container to the target container, and to automatically weigh the powder after powder-scooping and powder-dropping. Therefore, automated quantitative transfer of the powder sample is implemented. Compared with manual dispensing, the labor cost is reduced, and efficiency and accuracy for transferring the powder sample are improved. Moreover, with strong versatility, such method is applicable to transfer of various powder samples with different physical properties. The details are as follows.

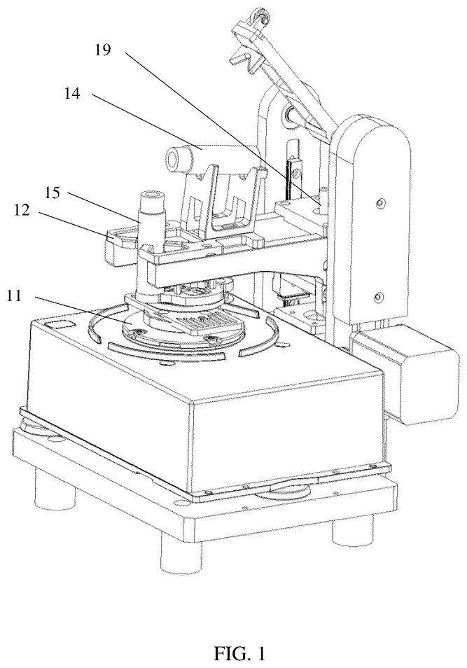

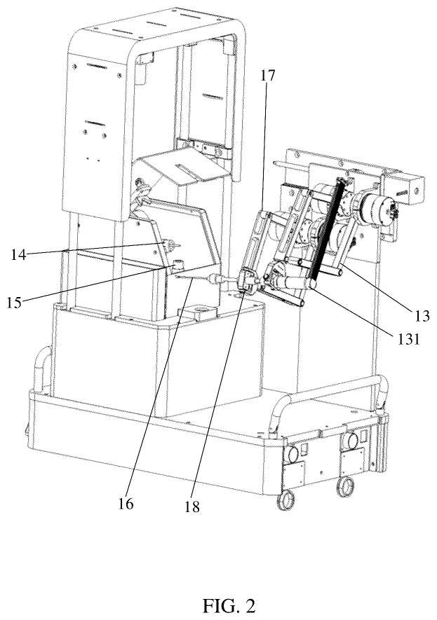

Reference is made to FIG. 1 and FIG. 2, where FIG. 1 is a structural schematic diagram of a powder-scooping system provided in embodiments of the disclosure, and FIG. 2 is a structural schematic diagram of another powder-scooping system provided in embodiments of the disclosure. As illustrated in FIG. 1 and FIG. 2, the powder-scooping system includes a weighing apparatus 11, a container base 12, and a powder-scooping-and-transferring apparatus 13. The container base 12 is used to place a source container 14 and a target container 15. The weighing apparatus 11 is located below the container base 12 and is used to weigh the container base 12 when the weighing apparatus 11 is in contact with the container base 12. The powder-scooping-and-transferring apparatus 13 is used to scoop powder from the source container 14 and transfer the scooped-powder into the target container 15.

As illustrated in FIG. 2, the powder-scooping-and-transferring apparatus 13 includes a scoop 16 and a powder-scooping manipulator 17. A fixing structure 18 is provided on the powder-scooping manipulator 17, and the fixing structure 18 is used to fix the scoop 16. The powder-scooping manipulator 17 includes multiple sections of mechanical arms. By controlling the movement of the mechanical arms, a multi-degree-of-freedom movement of the scoop 16 in three-dimensional space is implemented. Optionally, the powder-scooping-and-transferring apparatus 13 may further include a rotating mechanism 131 used to drive the scoop 16 to rotate around an axis of the scoop 16, to achieve powder-scooping or powder-dropping.

It can be understood that the scoop 16 in the powder-scooping-and-transferring apparatus 13 can be replaced by other structures. For example, it can be replaced by an adhesive rod with certain viscosity, which can stick a certain amount of powder from the source container 14 and then shake the powder off into the target container 15 to implement powder transfer. For another example, it can be replaced by a straw with a certain capacity, which can suck certain amount of powder from the source container 14 and then drop the powder into the target container 15 to implement powder transfer. The embodiments of the disclosure are not limited in this regard.

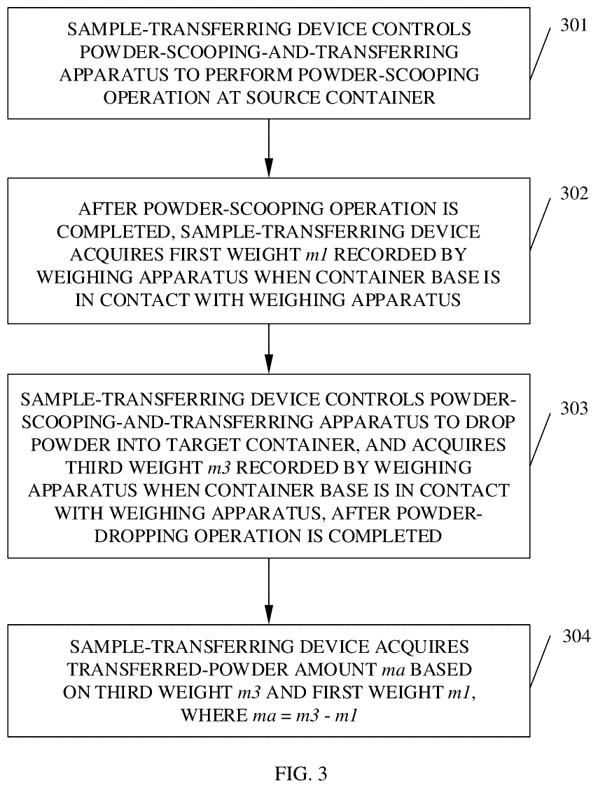

Reference is made to FIG. 3, where FIG. 3 is a schematic flow chart of a method for transferring the powder sample provided in embodiments of the disclosure. The method can be applicable to the aforementioned powder-scooping system. As illustrated in FIG. 3, the method may include the following operations.

At 301, a sample-transferring device controls a powder-scooping-and-transferring apparatus to perform a powder-scooping operation at a source container.

In embodiments of the disclosure, the sample-transferring device can be regarded as a component of the powder-scooping system. The sample-transferring device can communicate with the powder-scooping-and-transferring apparatus (through wireless communication or wired communication), and the sample-transferring device can send corresponding control instructions to the powder-scooping-and-transferring apparatus, to control the powder-scooping-and-transferring apparatus to perform operations such as moving, powder-scooping, powder-dropping, etc.

Taking an example where the powder-scooping-and-transferring apparatus has a scoop to describe the embodiments of the disclosure. The scoop is a precise instrument used to accurately scoop up a certain amount of powder, and a spoon-shaped metal tool with a recess at one end and a long handle. Scoops of different specifications have different capacities. The scoop can be replaced, to adapt to transfer of powder samples of different amounts. The sample-transferring device controls the powder-scooping-and-transferring apparatus to perform the powder-scooping operation at the source container specifically as follows. The sample-transferring device controls the scoop of the powder-scooping-and-transferring apparatus to perform the powder-scooping operation at the source container.

As illustrated in FIG. 1, the source container 14 and the target container 15 are placed on the container base 12. The source container 14 and the target container 15 can be containers such as a test tube, a centrifuge tube, a glass bottle, a plastic bottle, etc. The weighing apparatus 11 can include a balance and can function for weighing. The source container 14 and the target container 15 being placed on the container base 12 ensures stability of the source container 14 and the target container 15 during transferring the powder sample, and facilitates the balance to weigh items on the container base 12, that is, the balance can simultaneously weigh the container base 12, as well as the source container 14 and the target container 15 on the container base 12. As illustrated in FIG. 1, the powder-scooping system may also include a moving apparatus 19, which can be connected to at least one of the container base 12 or the weighing apparatus 11. The moving apparatus 19 can control the container base 12 to be in contact with or separate from the weighing apparatus 11, to meet weighing requirements in various scenarios. Exemplarily, the moving apparatus 19 can be a screw motor connected to the container base 12 or the weighing apparatus 11, and is used to drive the container base 12 or the weighing apparatus 11 to lift or lower.

The sample-transferring device controls the powder-scooping-and-transferring apparatus to perform the powder-scooping operation at the source container at 301 specifically as follows.

The sample-transferring device controls the moving apparatus to drive the container base to separate from the weighing apparatus. The sample-transferring device controls the powder-scooping-and-transferring apparatus to perform the powder-scooping operation at the source container when the container base is not in contact with the weighing apparatus.

In embodiments of the disclosure, the moving apparatus may drive the container base to separate from the weighing apparatus as follows. The moving apparatus drives the container base to move away from the weighing apparatus; or the moving apparatus drives the weighing apparatus to move away from the container base; or the moving apparatus drives both the container base and the weighing apparatus to move in opposite directions to separate the container base from the weighing apparatus. Preferably, to prevent the movement of the weighing apparatus from affecting weighing accuracy, the weighing apparatus is fixed, and the moving apparatus is connected to the container base to drive the container base to lift or lower, so that the container base can be in contact with or separate from the weighing apparatus. The powder-scooping-and-transferring apparatus is controlled to perform the powder-scooping operation at the source container when the container base is not in contact with the weighing apparatus, which can prevent the reading of the weighing apparatus from being affected by the scoop being in contact with an inner wall of the container during the powder-scooping operation.

The source container 14 can be a transparent container, which can facilitate the experimenter or a visual detection apparatus to observe or collect images of the powder in the source container 14. The target container 15 can be a transparent container, which can facilitate the experimenter or the visual detection apparatus to observe or collect images of the powder in the target container 15.

Optionally, the sample-transferring device may control the powder-scooping-and-transferring apparatus to perform the powder-scooping operation at the source container specifically at 301 as follows. The sample-transferring device determines a powder-scooping reference position in the source container, and controls the powder-scooping-and-transferring apparatus to move to the powder-scooping reference position and perform the powder-scooping operation according to a set powder-scooping movement. The set powder-scooping movement is determined based on at least one of an amount of powder in the source container, a current amount of power to-be-scooped, or a physical property parameter of the powder sample.

The powder-scooping reference position can be a starting position for the powder-scooping-and-transferring apparatus to perform the powder-scooping operation at the source container. By determining the powder-scooping reference position in the source container, the powder-scooping operation can be performed at the powder-scooping reference position, thereby improving powder-scooping effects of subsequent powder-scooping operations.

The powder-scooping reference position can be determined as any one of the following four methods. The powder-scooping reference position is determined through the visual detection apparatus; the powder-scooping reference position is determined through data recorded by the weighing apparatus; the powder-scooping reference position is determined through a pre-set powder-scooping reference position (for example, a manually-input powder-scooping reference position, or a coordinate of a powder-scooping reference position pre-stored in a memory of the sample-transferring device); and the powder-scooping reference position is determined through a previous powder-scooping reference position (for example, the powder-scooping reference position is determined based on a previous powder-scooping operation).

In embodiments of the disclosure, the sample-transferring device may control the powder-scooping-and-transferring apparatus to perform the powder-scooping operation at the source container according to the powder-scooping reference position specifically as follows. The sample-transferring device controls the scoop of the powder-scooping-and-transferring apparatus to perform the powder-scooping operation at the source container according to the powder-scooping reference position.

At 302, after the powder-scooping operation is completed, the sample-transferring device acquires a first weight m1 recorded by the weighing apparatus when the container base is in contact with the weighing apparatus.

In embodiments of the disclosure, the weighing apparatus may be an apparatus functioning for weighing. When the container base is in contact with the weighing apparatus, the weighing apparatus can weigh a total weight of the container base and items on the container base. When the container base is separated from the weighing apparatus, the weighing apparatus cannot weigh the total weight of the container base and the items on the container base.

The sample-transferring device can communicate with the weighing apparatus (through wireless communication or wired communication). The sample-transferring device can send corresponding acquisition instructions to the weighing apparatus to acquire a reading recorded by the weighing apparatus. Alternatively, the weighing apparatus can periodically send the recorded reading to the sample-transferring device. Alternatively, the weighing apparatus can send a changed reading to the sample-transferring device after detecting a change in the reading. The reading recorded by the weighing apparatus can be in weight units, such as XX grams (g), XX milligrams (mg), XX micrograms (ug), or XX nanograms (ng).

Optionally, at 302, after completing the powder-scooping operation, the sample-transferring device may acquire the first weight m1 recorded by the weighing apparatus when the container base is in contact with the weighing apparatus specifically as follows. The sample-transferring device controls the moving apparatus to drive the container base to be in contact with the weighing apparatus, after the powder-scooping operation is completed. The sample-transferring device acquires the first weight m1 recorded by the weighing apparatus when the container base is in contact with the weighing apparatus.

In embodiments of the disclosure, the container base being in contact with the weighing apparatus can be understood as the container base being completely placed on the weighing apparatus. Specifically, after the moving apparatus drives the container base to lower to be in contact with the weighing apparatus, driving force from the moving apparatus is removed, and the container base exerts force on the weighing apparatus by its own gravity. The first weight m1 recorded by the weighing apparatus when the container base is in contact with the weighing apparatus accurately records a total weight of the container base, the source container, and the target container on the weighing apparatus.

At 303, the sample-transferring device controls the powder-scooping-and-transferring apparatus to drop the powder into the target container, and acquires a third weight m3 recorded by the weighing apparatus when the container base is in contact with the weighing apparatus, after the powder-dropping operation is completed.

In embodiments of the disclosure, when controlling the powder-scooping-and-transferring apparatus to drop the powder into the target container, the powder-scooping-and-transferring apparatus can be controlled to move towards the target container. By controlling the powder-scooping-and-transferring apparatus to perform the powder-dropping operation after the scoop of the powder-scooping-and-transferring apparatus reaches an opening of the target container, the amount of powder that spilled from the scoop of the powder-scooping-and-transferring apparatus and dropped outside the target container can be minimized.

In one example, when the powder-scooping-and-transferring apparatus drops the powder into the target container, the container base can remain in contact with the weighing apparatus, and weighing data recorded by the weighing apparatus is directly read after the powder is dropped. Such operation can improve efficiency of sample-transferring.

In another example, before the powder-scooping-and-transferring apparatus drops the powder into the target container, the container base can first be separated from the weighing apparatus, and the powder-dropping operation is performed when the container base is not in contact with the weighing apparatus. The weighing data recorded by the weighing apparatus is read when the container base is made to be in contact with the weighing apparatus again after the powder is dropped. Such operation can prevent the weighing accuracy of the weighing apparatus from being affected by the scoop being in contact with a wall of the container during powder-dropping.

At 304, the sample-transferring device acquires a transferred-powder amount ma based on the third weight m3 and the first weight m1, where ma=m3−m1.

In the embodiment of the disclosure, operations at 301 to 304 compose a process of one powder transfer. The transferred-powder amount ma can be acquired through the weight increment method, therefore the automated quantitative transfer of the powder sample is implemented, and the efficiency and accuracy for transferring the powder sample are improved.

The number of times of the powder transfer can be determined according to the transferred-powder amount ma and a required total transferred-powder amount, to repeatedly execute operations at 301 to 304.

In the embodiment of the disclosure, the powder-scooping-and-transferring apparatus can be controlled to perform the powder-scooping operation at the source container and to perform the powder-dropping operation to transfer the powder from the source container to the target container, and can automatically weigh the powder after powder-scooping and powder-dropping. Therefore, automated quantitative transfer of powder sample is implemented. Compared with manual dispensing, the labor cost is reduced, and the efficiency and accuracy for transferring the powder sample are improved.

In addition, by controlling the powder-scooping-and-transferring apparatus to perform the powder-scooping operation at the source container according to the powder-scooping reference position, risk of empty scooping is reduced and accuracy of powder-scooping is improved. By scooping the powder from the source container and dropping the scooped powder into the target container using the powder-scooping-and-transferring apparatus, in combination with automatic weighing through the weighing apparatus, efficient quantitative transfer of the powder sample can be implemented. Such method can be applicable to various powder samples with different physical properties, therefore the efficiency, accuracy, and powder adaptability for transferring the powder sample are improved.

Optionally, the sample-transferring device may control the powder-scooping-and-transferring apparatus to drop the powder into the target container specifically at 303 as follows. The powder-scooping-and-transferring apparatus is controlled to move to the opening of the target container, and to acquire a second weight m2 recorded by the weighing apparatus when the container base is in contact with the weighing apparatus. The powder-scooping-and-transferring apparatus is controlled to drop the powder via the opening of the target container into the target container.

Correspondingly, the transferred-powder amount ma may be acquired based on the third weight m3 and the first weight m1 at 304 specifically as follows. The transferred-powder amount ma is acquired based on the third weight m3 and the second weight m2, where ma=m3−m2.

The sample-transferring device acquires the first weight m1 recorded by the weighing apparatus after the powder-scooping operation is completed. The sample-transferring device then acquires the second weight m2 recorded by the weighing apparatus after controlling the powder-scooping-and-transferring apparatus to move to the opening of the target container. When no powder on the scoop of the powder-scooping-and-transferring apparatus is spilled during the movement of the powder-scooping-and-transferring apparatus to the opening of the target container, m1=m2. When some powders on the scoop are spilled during the movement to the opening of the target container, m2 is greater than m1, and a spilled amount is equal to m2−m1. By considering a powder loss during transferring, the accuracy of powder transfer can be further improved.

Optionally, the powder-scooping-and-transferring apparatus may be controlled to drop the powder from the opening of the target container into the target container specifically as follows. The scoop is controlled to move from the opening of the target container to a powder-dropping position in the target container. The scoop is controlled to rotate with a pre-set angle and to shake with a fourth amplitude to complete the powder-dropping. The pre-set angle is greater than or equal to 90° and less than or equal to 180°.

In the embodiment of the disclosure, the powder-dropping position may be a pre-set position in the target container. The powder-dropping position can be set at a position in the target container where it is not easy for the powder to spill out of the target container. For example, the powder-dropping position can be set at a position in the target container that is far from the opening, such as 10 mm inward from the opening. In the embodiment of the disclosure, when the powder-dropping operation is performed at the powder-dropping position, the powder can be ensured to not spill out of the target container.

The pre-set angle can be set in advance. Setting the pre-set angle to be greater than or equal to 90° and less than or equal to 180° can allow the powder on the scoop to be dropped into the target container due to gravity. For example, the pre-set angle can be 90°, 100°, 110°, 120°, 130°, 135°, 140°, 150°, 160°, 170°, 180°, or other values.

The fourth amplitude can be a pre-set default value, or the fourth amplitude can be set according to a physical property of the powder. For example, the greater the viscosity of the powder sample, the greater the fourth amplitude can be set. Controlling the scoop to shake with the fourth amplitude enables as much powder on the scoop as possible to be dropped into the target container, while also protecting the scoop from being damaged by shaking with an excessively great amplitude.

Exemplarily, when the weighing apparatus is the balance, and the powder-scooping-and-transferring apparatus includes the powder-scooping manipulator and the scoop, a process of the powder-dropping operation can be as follows. The container base is kept to be in contact with the balance. The powder-scooping manipulator controls the scoop to perform a horizontal, gradual, and stable displacement, and the scoop is moved to a position po of the opening of the target container. The powder-scooping manipulator controls the scoop to perform a vertical, gradual, and stable displacement, and the scoop is moved to a powder-dropping position pd at the opening of the target container. The powder-scooping manipulator controls the scoop to rotate for 90° clockwise to drop the powder into the target container, and then controls the scoop to shake with an amplitude d′ to ensure that as much powder on the scoop as possible is dropped into the target container. The scoop is restored to its original state to complete the powder-dropping operation. In this regard, a reading m3 of the balance is acquired, and an actual transferred-powder amount ma can be calculated by the weight increment method.

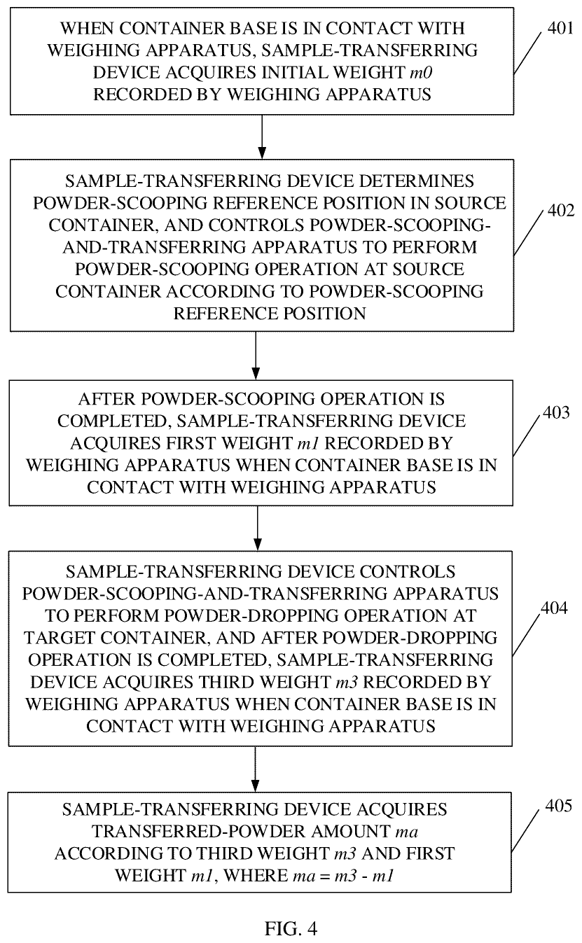

Reference can be made to FIG. 4, where FIG. 4 is a schematic flow chart of another method for transferring the powder sample provided in embodiments of the disclosure. As illustrated in FIG. 4, the method may include the following operations.

At 401, when the container base is in contact with the weighing apparatus, the sample-transferring device acquires an initial weight m0 recorded by the weighing apparatus.

In the embodiment of the disclosure, prior to executing the process of powder transfer for the first time, and after placing the source container and the target container on the container base, the sample-transferring device can acquire the initial weight m0 recorded by the weighing apparatus. The initial weight m0 may be a total weight of the container base, the source container and the powder sample therein, and the target container.

At 402, the sample-transferring device determines the powder-scooping reference position in the source container, and controls the powder-scooping-and-transferring apparatus to perform the powder-scooping operation at the source container according to the powder-scooping reference position.

Optionally, the sample-transferring device may determine the powder-scooping reference position in the source container at 402 specifically as follows. The sample-transferring device determines the powder-scooping reference position in the source container based on a recording of the weighing apparatus. Optionally, the sample-transferring device determines the powder-scooping reference position in the source container based on the visual detection apparatus.

In the embodiment of the disclosure, modes for determining the powder-scooping reference position in the source container can include a mode based on the recording of the weighing apparatus and a mode based on detection by the visual detection apparatus.

For the mode based on the recording of the weighing apparatus, the powder-scooping-and-transferring apparatus can be moved, and during the movement of the powder-scooping-and-transferring apparatus (that is, during discovering for the powder-scooping reference position), whether the powder-scooping reference position has been discovered is determined by detecting whether the reading recorded by the weighing apparatus changes. Therefore, the powder-scooping reference position can be discovered accurately, and accuracy of subsequent powder-scooping operation is improved.

The mode based on detection by the visual detection apparatus can quickly detect a profile of the powder in the source container through the visual detection apparatus, to quickly discover the powder-scooping reference position, thereby improving the efficiency of sample-transferring.

Optionally, the sample-transferring device may determine the powder-scooping reference position in the source container based on the recording of the weighing apparatus specifically as follows. The sample-transferring device controls the powder-scooping-and-transferring apparatus to move to a fixed position to perform the powder-scooping operation, and acquires a weight m0′ recorded by the weighing apparatus when the container base is in contact with the weighing apparatus. The sample-transferring device determines the fixed position as the powder-scooping starting position in the source container if m0′ is less than m0. The sample-transferring device controls the powder-scooping-and-transferring apparatus to move to a next position according to a set step-length and a set direction if m0′ is equal to m0, to perform the powder-scooping operation until m0′ is less than m0, and determines a position reached by the last movement as the powder-scooping starting position in the source container. The sample-transferring device determines the powder-scooping reference position in the source container based on the powder-scooping starting position.

In the embodiment of the disclosure, the powder-scooping starting position can be directly used as the powder-scooping reference position, or the powder-scooping reference position can be acquired by adding a powder-scooping offset to the powder-scooping starting position. The powder-scooping offset can be set as a fixed value, or can be determined based on the physical property of the powder sample in the source container (such as the powder hardness, the density, the particle size, etc.). The powder-scooping offset can be a test empirical value, which is related to the physical property of the powder sample.

The fixed position can be a default position, an empirically derived position, or a powder-scooping reference position determined from the previous powder-scooping operation, which is not limited herein.

The set step-length and set direction can be pre-set. For example, the set step-length and set direction can be empirical values, such as moving forward horizontally by a step-length of 1 mm each time, or moving forward in an extending direction of a scoop by a step-length of 1 mm each time.

The above operations are processes of automatically discovering the powder-scooping reference position, with the purpose of detecting an edge of the powder. The powder-scooping reference position can ensure that a relatively large amount of powder can be scooped without sticking the powder on a handle of the scoop (which may cause the powder to easily spill out of the target container during powder-dropping). There can be an offset between the edge of the powder and an appropriate powder-scooping starting position, and the offset is related to the physical property of the powder.

Optionally, the sample-transferring device may determine the powder-scooping reference position in the source container based on the powder-scooping starting position as follows. The sample-transferring device acquires a physical property parameter of the powder sample in the source container. The sample-transferring device determines a corresponding powder-scooping offset according to the physical property parameter of the powder sample. The sample-transferring device determines the powder-scooping reference position in the source container based on the powder-scooping starting position and the corresponding powder-scooping offset.

The physical property parameter of the powder sample may include, but is not limited to, at least one of the hardness, the density, the particle size, the specific surface area, the viscosity, the fluidity, the agglomeration, or the hygroscopicity, etc. of the powder sample. The powder-scooping offset can be acquired empirically, and different powder samples with different physical properties may correspond to different powder-scooping offsets. Exemplarily, a mapping relationship between physical property parameters of the powder sample and powder-scooping offsets can be established in advance. For instance, powder samples with different hardness correspond to different powder-scooping offsets, or powder samples with different particle sizes correspond to different powder-scooping offsets. After acquiring the physical property parameter of the powder sample, the corresponding powder-scooping offset can be found through the mapping relationship. The physical property parameter of the powder sample can be manually input, automatically identified by a device, or acquired by the device from a database, which is not limited herein.

In the embodiment of the disclosure, a coordinate of the powder-scooping reference position in the source container can be acquired by adding the powder-scooping offset to a coordinate of the powder-scooping starting position.

The weighing apparatus can be the balance, and the mode based on the recording of the weighing apparatus can be a detection mode based on the reading of the balance.

Exemplarily, the powder-scooping reference position in the source container is determined based on the recording of the balance as follows. The source container containing powder and the target container are placed on the container base, the container base is in contact with the balance, and the initial weight m0 is acquired. The scoop is controlled to move to a fixed position p0 to perform powder-scooping, and the reading of the balance is recorded. If the reading of the balance is less than m0, the position p0 can be used as the powder-scooping starting position; and if the reading of the balance remains unchanged, no powder has been scooped yet, and the scoop is controlled to continue to move to the next position until the balance reading is less than m0, and the powder-scooping starting position is confirmed to be at pn. Then the physical property parameter of the powder sample is input to acquire a powder-scooping offset delta_p, and finally the powder-scooping reference position is output as (pn+delta_p).

Optionally, the sample-transferring device may control the powder-scooping-and-transferring apparatus to perform the powder-scooping operation at the source container according to the powder-scooping reference position at 402 as follows. The sample-transferring device controls the powder-scooping-and-transferring apparatus to move to the powder-scooping reference position and perform the powder-scooping operation according to the set powder-scooping movement. The set powder-scooping movement is determined based on at least one of an amount of powder in the source container, a current amount of powder to-be-scooped, or the physical property parameter of the powder sample.

In the embodiment of the disclosure, the set powder-scooping movement can be regarded as a movement trajectory of the powder-scooping-and-transferring apparatus during the powder-scooping. Optionally, the set powder-scooping movement can be a set of default movement-trajectories. Optionally, the set powder-scooping movement can be determined based on one or a combination of the amount of the powder in the source container, the current amount of powder to-be-scooped, and the physical property parameter of the powder sample (such as agglomeration, viscosity, fluidity, particle size, hardness of the powder, etc.). For example, a mapping table between different powder amounts and powder-scooping movements can be established in advance, or a mapping table between different current amounts of powder to-be-scooped and powder-scooping movements can be established in advance, or a mapping table between different physical property parameters of powder samples and powder-scooping movements can be established in advance, or a mapping table between different powder amounts and physical property parameters and powder-scooping movements can be established in advance, etc.

The powder-scooping operation in the disclosure can adopt different powder-scooping movements according to powders with different physical properties, thereby improving the adaptability and accuracy of the powder-scooping operation.

At 403, after the powder-scooping operation is completed, the sample-transferring device acquires the first weight m1 recorded by the weighing apparatus when the container base is in contact with the weighing apparatus.

At 404, the sample-transferring device controls the powder-scooping-and-transferring apparatus to perform the powder-dropping operation at the target container, and after the powder-dropping operation is completed, the sample-transferring device acquires the third weight m3 recorded by the weighing apparatus when the container base is in contact with the weighing apparatus.

At 405, the sample-transferring device acquires the transferred-powder amount ma according to the third weight m3 and the first weight m1, where ma=m3−m1.

For specific implementations of operations at 402 to 405, reference can be made to relevant contents of foregoing operations at 301 to 304, which will not be repeated herein.

In the embodiment of the disclosure, the powder-scooping-and-transferring apparatus can be controlled to perform the powder-scooping operation at the source container according to the powder-scooping reference position, to reduce the risk of empty scooping and improve the accuracy of powder-scooping. The powder-scooping-and-transferring apparatus can also be controlled to perform the powder-dropping operation to transfer the powder from the source container to the target container, therefore automated and efficient transfer of powder sample is implemented. Compared with manual dispensing, the labor cost is reduced, and such method can be applicable to various powder samples with different physical properties. In addition, the transferred-powder amount ma can be calculated accurately through a weight recorded by the weighing apparatus, therefore the accuracy and powder adaptability for transferring the powder sample are improved.

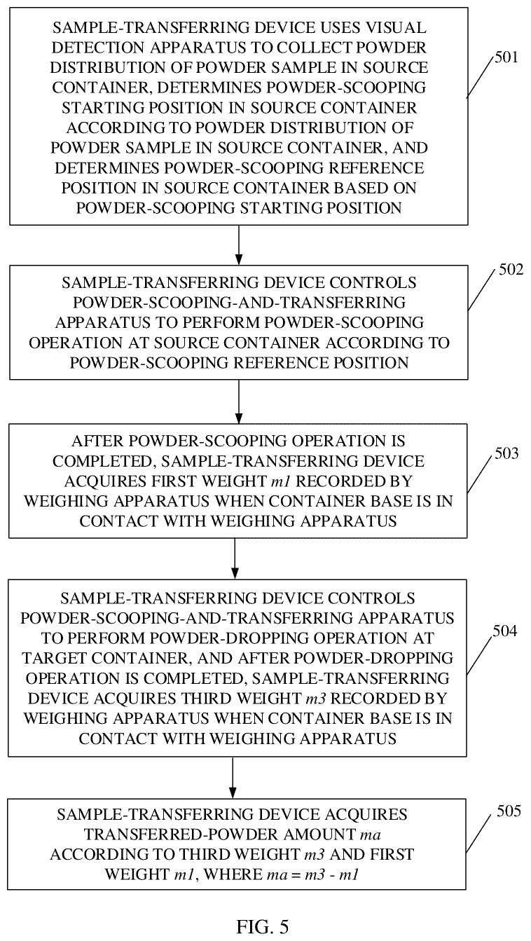

Reference can be made to FIG. 5, which is a schematic flow chart of another method for transferring the powder sample provided in the embodiment of the disclosure. As illustrated in FIG. 5, the method may include the following operations.

At 501, the sample-transferring device uses the visual detection apparatus to collect a powder distribution of the powder sample in the source container, determines the powder-scooping starting position in the source container according to the powder distribution of the powder sample in the source container, and determines the powder-scooping reference position in the source container based on the powder-scooping starting position.

In the embodiment of the disclosure, the powder distribution of the powder sample in the source container may include a three-dimensional profile of a powder pile formed by the powder sample in the source container. The powder distribution can reflect an edge of the powder. After acquiring the powder distribution, the edge of the powder can be recognized based on existing related technologies (such as Sobel operator, Canny operator, Laplacian operator, etc., in edge detection), and one position at the edge of the powder can be used as the powder-scooping starting position.

For specific implementations of the sample-transferring device determining the powder-scooping reference position in the source container based on the powder-scooping starting position at 501, reference can be made to description of foregoing operations, which will not be repeated herein.

Optionally, the visual detection apparatus includes a top visual acquisition module and a side visual acquisition module. The sample-transferring device may collect the powder distribution of the powder sample in the source container using the visual detection apparatus specifically at 501 as follows. The sample-transferring device photographs the source container from top using the top visual acquisition module, and inputs an acquired image in a top view into a first visual model to acquire a powder profile in the top view. The sample-transferring device photographs the source container from side using the side visual acquisition module, and inputs an acquired image in a side view into a second visual model to acquire a powder profile in the side view. The sample-transferring device performs three-dimensional fusion on the powder profile in the top view and the powder profile in the side view to acquire the powder distribution of the powder sample in the source container.

In the embodiment of the disclosure, the top visual acquisition module can be disposed above the source container, and the side visual acquisition module can be disposed on a side of the source container. The top visual acquisition module and the side visual acquisition module are apparatuses with visual collection functions, such as cameras. Both the first visual model and the second visual model can be pre-trained models, and the first visual model and the second visual model can be two different models or the same model, which is not limited herein. The three-dimensional fusion can adopt existing related technologies, which is not described in detail in the disclosure.

The sample-transferring device can communicate with the top visual acquisition module (through wireless communication or wired communication), and the sample-transferring device can send corresponding control instructions to the top visual acquisition module, to control the top visual acquisition module to photograph from the top, and acquires the image in the top view photographed by the top visual acquisition module. The sample-transferring device can communicate with the side visual acquisition module (through wireless communication or wired communication), and the sample-transferring device can send the corresponding control instructions to the side visual acquisition module, to control the side visual acquisition module to photograph from the side, and acquires the image in the side view photographed by the side visual acquisition module.

In the above process, by acquiring the powder profile in the top view through the first visual model, acquiring the powder profile in the side view through the second visual model, and performing the three-dimensional fusion on the powder profile in the top view and the powder profile in the side view, a three-dimensional powder profile is acquired, therefore the edge of the powder is determined.

Taking an example where the visual detection apparatus is the camera, a mode based on detection of the visual detection apparatus can be implemented as follows. The source container containing the powder and the target container are placed on the container base, the container base is in contact with the balance, and the initial weight m0 is acquired. A top camera (i.e., the top visual acquisition module) is used to photograph the source container from the top, the acquired image is input into model M1 (i.e., the first visual model) for recognition, and the powder profile in the top view is acquired. A side camera is used to photograph the source container from the side, the acquired image is input into model M2 (i.e., the second visual model) for recognition, and the powder profile in the side view is acquired. The three-dimensional fusion is performed on the powder profile in the top view and the powder profile in the side view to acquire an actual powder distribution. The edge of the powder is calculated to be at pn according to the powder distribution, then the powder-scooping offset delta_p is acquired according to an input physical property parameter of the powder sample, and the powder-scooping reference position is finally output as (pn+delta_p).

At 502, the sample-transferring device controls the powder-scooping-and-transferring apparatus to perform the powder-scooping operation at the source container according to the powder-scooping reference position.

For specific implementations at 502, reference can be made to relevant descriptions of foregoing operations at 301 and at 402, which will not be repeated herein.

At 503, after the powder-scooping operation is completed, the sample-transferring device acquires the first weight m1 recorded by the weighing apparatus when the container base is in contact with the weighing apparatus.

At 504, the sample-transferring device controls the powder-scooping-and-transferring apparatus to perform the powder-dropping operation at the target container, and after the powder-dropping operation is completed, the sample-transferring device acquires the third weight m3 recorded by the weighing apparatus when the container base is in contact with the weighing apparatus.

At 505, the sample-transferring device acquires the transferred-powder amount ma according to the third weight m3 and the first weight m1, where ma=m3−m1.

For specific implementations of operations at 503 to 505, reference can be made to relevant contents of foregoing operations at 302 to 304, which will not be repeated herein.

In the embodiment of the disclosure, by controlling the powder-scooping-and-transferring apparatus to perform the powder-scooping operation at the source container according to the powder-scooping reference position, the risk of empty scooping can be reduced and the accuracy of powder-scooping can be improved. The visual detection apparatus can be used to determine the powder-scooping reference position in the source container without participation of the weighing apparatus, which can improve operation efficiency and quickly determine the powder-scooping reference position. In addition, the powder-scooping-and-transferring apparatus can be controlled to perform the powder-dropping operation, to transfer the powder from the source container to the target container, therefore automated and efficient transfer of the powder sample is implemented. Compared with manual dispensing, the labor cost is reduced, and such method can be applicable to various powder samples with different physical properties. Moreover, the transferred-powder amount ma can be calculated accurately through the weight recorded by the weighing apparatus, therefore the accuracy and powder adaptability for transferring the powder sample are improved.

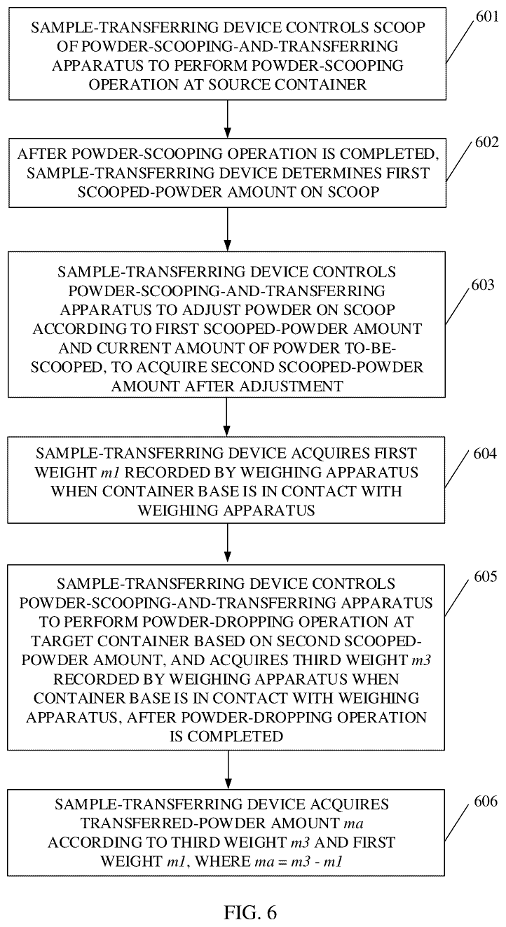

Reference can be made to FIG. 6, where FIG. 6 is a schematic flow chart of another method for transferring the powder sample provided in the embodiment of the disclosure. As illustrated in FIG. 6, the method may include the following operations.

At 601, the sample-transferring device controls the scoop of the powder-scooping-and-transferring apparatus to perform the powder-scooping operation at the source container.

At 602, after the powder-scooping operation is completed, the sample-transferring device determines a first scooped-powder amount on the scoop.

In the embodiment of the disclosure, the first scooped-powder amount on the scoop can be determined by the visual detection apparatus or through data recorded by the weighing apparatus.

Optionally, the powder-scooping system further includes the visual detection apparatus. The sample-transferring device may determine the first scooped-powder amount on the scoop at 602 specifically as follows. The sample-transferring device collects a powder distribution on the scoop with the visual detection apparatus. The sample-transferring device determines the first scooped-powder amount on the scoop based on the powder distribution and a visual prediction model. The visual prediction model is used to reflect corresponding relationships between different powder distributions and powder amounts.

In the embodiment of the disclosure, the visual detection apparatus can collect at least one image containing the scoop, and can determine the powder distribution on the scoop with at least one image containing the scoop. The visual detection apparatus can collect images of the scoop from different angles, and fuse different images to acquire the powder distribution on the scoop. The powder distribution on the scoop may include the three-dimensional profile of the powder pile formed by the powder on the scoop. There is a corresponding relationship between the powder distribution and the powder amount, and the visual prediction model can reflect corresponding relationships between different powder distributions and powder amounts. By inputting the powder distribution into the visual prediction model, the first scooped-powder amount on the scoop can be acquired.

In the embodiment of the disclosure, the first scooped-powder amount on the scoop can be determined through the visual detection apparatus and the visual prediction model without participation of the weighing apparatus, that is, a scooped-powder amount on the scoop can be determined without lowering the container base to come into contact with the weighing apparatus for weighing, which can improve the operation efficiency.

The visual prediction model may be a trained visual prediction model. The visual prediction model can be trained as follows. A training sample is input into an initial visual prediction model to acquire a prediction result output by the visual prediction model. The training sample includes the powder distribution on the scoop and a corresponding weighed-powder amount. A training loss is acquired according to the prediction result and the corresponding powder distribution on the scoop, and a parameter of the visual prediction model is updated according to the training loss until the training loss meets a corresponding training completion condition, and then the trained visual prediction model can be acquired.

At 603, the sample-transferring device controls the powder-scooping-and-transferring apparatus to adjust the powder on the scoop according to the first scooped-powder amount and the current amount of powder to-be-scooped, to acquire a second scooped-powder amount after adjustment.

In the embodiment of the disclosure, the powder-scooping-and-transferring apparatus can be controlled to adjust the powder on the scoop, so that the second scooped-powder amount after adjustment is close to the current amount of powder to-be-scooped. Exemplarily, an absolute value of a difference between the second scooped-powder amount after adjustment and the current amount of powder to-be-scooped can be less than or equal to an allowable deviation. For controlling the powder-scooping-and-transferring apparatus to adjust the powder on the scoop, it is preferably carried out when the container base is in contact with the weighing apparatus, so as to improve adjustment efficiency.

At 604, the sample-transferring device acquires the first weight m1 recorded by the weighing apparatus when the container base is in contact with the weighing apparatus.

At 605, the sample-transferring device controls the powder-scooping-and-transferring apparatus to perform the powder-dropping operation at the target container based on the second scooped-powder amount, and acquires the third weight m3 recorded by the weighing apparatus when the container base is in contact with the weighing apparatus, after the powder-dropping operation is completed.

In the embodiment of the disclosure, the sample-transferring device controls the powder-scooping-and-transferring apparatus to perform the powder-dropping operation at the target container based on the second scooped-powder amount, therefore an amount of powder that dropped by the powder-scooping-and-transferring apparatus into the target container meets the expectation.

At 606, the sample-transferring device acquires the transferred-powder amount ma according to the third weight m3 and the first weight m1, where ma=m3−m1.

For specific implementations of operations at 601, 604, 605, and 606, reference can be made to detailed descriptions of foregoing operations at 301 to 304, which will not be repeated herein.

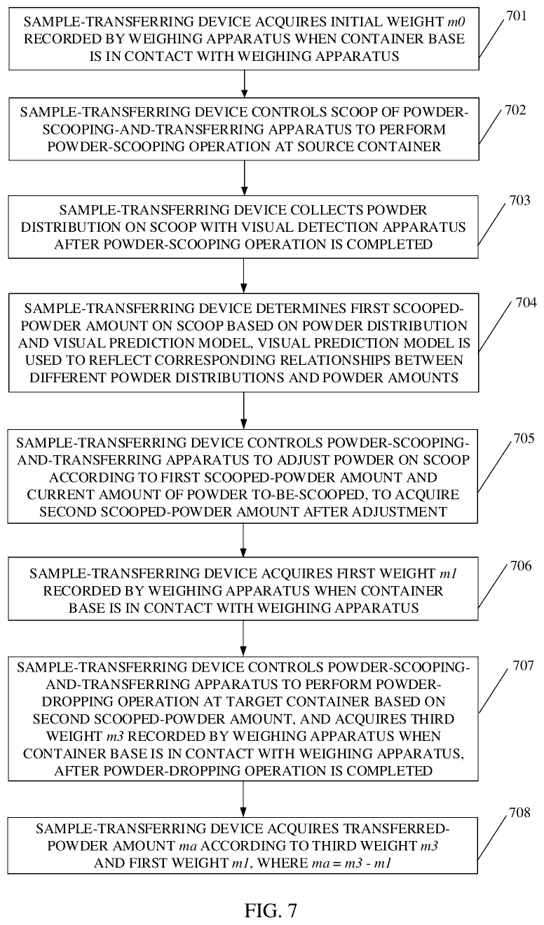

Reference can be made to FIG. 7, where FIG. 7 is a schematic flow chart of another method for transferring the powder sample provided in the embodiment of the disclosure. As illustrated in FIG. 7, the method may include the following operations.

At 701, the sample-transferring device acquires the initial weight m0 recorded by the weighing apparatus when the container base is in contact with the weighing apparatus.

In the embodiment of the disclosure, prior to executing the process of powder transfer for the first time, and after placing the source container and the target container on the container base, the sample-transferring device can acquire the initial weight m0 recorded by the weighing apparatus. The initial weight m0 may be a total weight of the container base, the source container and the powder sample therein, and the target container.

At 702, the sample-transferring device controls the scoop of the powder-scooping-and-transferring apparatus to perform the powder-scooping operation at the source container.

For specific implementations of at 702, reference can be made to detailed description of foregoing operations at 301 or at 402, which will not be repeated herein.

At 703, the sample-transferring device collects the powder distribution on the scoop with the visual detection apparatus after the powder-scooping operation is completed.

At 704, the sample-transferring device determines the first scooped-powder amount on the scoop based on the powder distribution and the visual prediction model. The visual prediction model is used to reflect corresponding relationships between different powder distributions and powder amounts.

For specific implementations of operations at 703 and at 704, reference can be made to detailed descriptions of foregoing operations, which will not be repeated herein.

At 705, the sample-transferring device controls the powder-scooping-and-transferring apparatus to adjust the powder on the scoop according to the first scooped-powder amount and the current amount of powder to-be-scooped, to acquire the second scooped-powder amount after adjustment.

At 706, the sample-transferring device acquires the first weight m1 recorded by the weighing apparatus when the container base is in contact with the weighing apparatus.

After executing operations at 706, the following operations can also be executed. The sample-transferring device acquires an actual scooped-powder amount on the scoop according to the initial weight m0 and the first weight m1. The sample-transferring device calculates a deviation between the actual scooped-powder amount and the first scooped-powder amount, and fine-tunes the visual prediction model based on the deviation to acquire a new visual prediction model.

In the embodiment of the disclosure, if the actual scooped-powder amount on the scoop is referred to as ms, ms=m0−m1. The first scooped-powder amount is a powder amount predicted by the visual prediction model. If the first scooped-powder amount is referred to as mc, the deviation may be equal to (ms−mc), or the deviation may be equal to (mc−ms), or the deviation may be equal to an absolute value of (ms−mc).

In general, the closer the deviation is to 0, the more accurate the prediction result of the visual prediction model is. By fine-tuning the visual prediction model based on the deviation to acquire the new visual prediction model, the prediction result of the new visual prediction model can be closer to the actual value, thereby improving prediction accuracy of the visual prediction model. Optionally, the visual prediction model may be fine-tuned based on the deviation specifically as follows. When the absolute value of the deviation exceeds a pre-set allowable deviation range, the powder distribution on the scoop collected by the visual detection apparatus at this time is mapped with the actual scooped-powder amount ms, and is input into the visual prediction model as a new training sample for training, so as to fine-tune and update the visual prediction model. When the absolute value of the deviation is within the pre-set allowable deviation range, the visual prediction model may not be fine-tuned at this time.

At 707, the sample-transferring device controls the powder-scooping-and-transferring apparatus to perform the powder-dropping operation at the target container based on the second scooped-powder amount, and acquires the third weight m3 recorded by the weighing apparatus when the container base is in contact with the weighing apparatus, after the powder-dropping operation is completed.

At 708, the sample-transferring device acquires the transferred-powder amount ma according to the third weight m3 and the first weight m1, where ma=m3−m1.

For specific implementations of operations at 705 to 708, reference can be made to foregoing operations at 603 to 606, which will not be repeated herein.

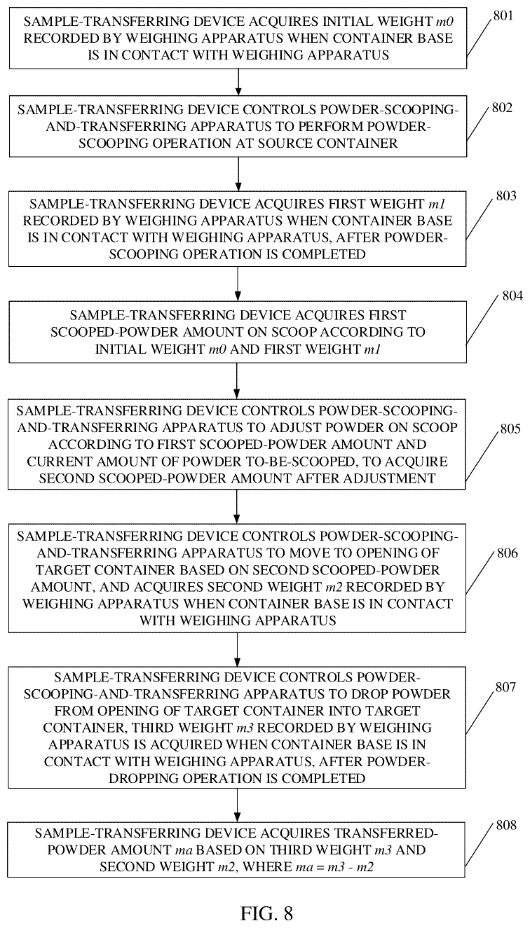

Reference can be made to FIG. 8, where FIG. 8 is a schematic flow chart of another method for transferring the powder sample provided in the embodiment of the disclosure. As illustrated in FIG. 8, the method may include the following operations.

At 801, the sample-transferring device acquires the initial weight m0 recorded by the weighing apparatus when the container base is in contact with the weighing apparatus.

In the embodiment of the disclosure, prior to executing the process of powder transfer for the first time, and after placing the source container and the target container on the container base, the sample-transferring device acquires the initial weight m0 recorded by the weighing apparatus.

At 802, the sample-transferring device controls the powder-scooping-and-transferring apparatus to perform the powder-scooping operation at the source container.

For specific implementation of at 802, reference can be made to detailed description of foregoing operations at 301 or at 402, which will not be repeated herein.

At 803, the sample-transferring device acquires the first weight m1 recorded by the weighing apparatus when the container base is in contact with the weighing apparatus, after the powder-scooping operation is completed.

For specific implementations of operations at 803, reference can be made to detailed description of foregoing at 302, which will not be repeated herein.

At 804, the sample-transferring device acquires the first scooped-powder amount on the scoop according to the initial weight m0 and the first weight m1.

The first scooped-powder amount is the actual scooped-powder amount on the scoop ms, where ms=m0−m1.

In the embodiment of the disclosure, the first scooped-powder amount can be acquired according to the initial weight m0 and the first weight m1 recorded by the weighing apparatus, that is, the actual scooped-powder amount of the scoop can be acquired accurately through the weight reduction method.

At 805, the sample-transferring device controls the powder-scooping-and-transferring apparatus to adjust the powder on the scoop according to the first scooped-powder amount and the current amount of powder to-be-scooped, to acquire the second scooped-powder amount after adjustment.

For specific implementations of at 805, reference can be made to detailed description of operations at 603, which will not be repeated herein.

At 806, the sample-transferring device controls the powder-scooping-and-transferring apparatus to move to the opening of the target container based on the second scooped-powder amount, and acquires the second weight m2 recorded by the weighing apparatus when the container base is in contact with the weighing apparatus.

In the embodiment of the disclosure, the sample-transferring device may control the powder-scooping-and-transferring apparatus to move to the opening of the target container specifically as follows. The sample-transferring device controls the scoop of the powder-scooping-and-transferring apparatus to move to the opening of the target container.

Optionally, after executing operations at 806, the following operations can also be executed. The sample-transferring device acquires the powder loss during transferring mw based on the first weight m1 and the second weight m2, where mw=m2−m1.

The powder loss during transferring mw refers to an amount of powder spilled from the scoop during the movement of the powder-scooping-and-transferring apparatus to the opening of the target container. In the embodiment of the disclosure, the amount of the spilled-powder during the movement of the powder-scooping-and-transferring apparatus to the opening of the target container can be calculated accurately, thereby providing a reference for subsequent powder transfer. An algorithm in operations at 806, by which the sample-transferring device controls the powder-scooping-and-transferring apparatus to move to the opening of the target container, can be optimized based on the powder loss during transferring mw, to reduce the amount of the spilled-powder during the movement.

At 807, the sample-transferring device controls the powder-scooping-and-transferring apparatus to drop the powder from the opening of the target container into the target container. The third weight m3 recorded by the weighing apparatus is acquired when the container base is in contact with the weighing apparatus, after the powder-dropping operation is completed.

In the embodiment of the disclosure, after the powder-scooping-and-transferring apparatus moves to the opening of the target container, the powder-scooping-and-transferring apparatus is controlled to perform the powder-dropping operation to ensure that as much powder on a scoop of the powder-scooping-and-transferring apparatus as possible is dropped into the target container.

At 808, the sample-transferring device acquires the transferred-powder amount ma based on the third weight m3 and the second weight m2, where ma=m3−m2.

In the embodiment of the disclosure, after the sample-transferring device controls the powder-scooping-and-transferring apparatus to move to the opening of the target container, the sample-transferring device acquires the second weight m2 recorded by the weighing apparatus prior to the powder-dropping operation, and the sample-transferring device acquires the third weight m3 recorded by the weighing apparatus after the powder-dropping operation is completed. The transferred-powder amount ma can be acquired accurately based on the third weight m3 and the second weight m2 recorded by the weighing apparatus, therefore an accurate transferred-powder amount is acquired, and the accuracy for transferring the powder sample is improved.

Optionally, the sample-transferring device may control the powder-scooping-and-transferring apparatus to adjust the powder on the scoop according to the first scooped-powder amount and the current amount of powder to-be-scooped, to acquire the second scooped-powder amount after adjustment at 705 and at 805 specifically, as follows.

The sample-transferring device controls the first scooped-powder amount on the scoop to remain unadjusted and takes the first scooped-powder amount as the second scooped-powder amount, when the first scooped-powder amount is less than or equal to a first threshold and greater than or equal to a second threshold. The first threshold is equal to a sum of the current amount of powder to-be-scooped and the allowable deviation. The second threshold is equal to a difference between the current amount of powder to-be-scooped and the allowable deviation.

The sample-transferring device controls the powder-scooping-and-transferring apparatus to implement a downward adjustment strategy to reduce the powder on the scoop, when the first scooped-powder amount is greater than the first threshold, to acquire the second scooped-powder amount after adjustment. The downward adjustment strategy includes controlling the powder-scooping-and-transferring apparatus to shake the scoop until the scooped-powder amount on the scoop is less than or equal to the first threshold and greater than or equal to the second threshold.

The sample-transferring device controls the powder-scooping-and-transferring apparatus to implement an upward adjustment strategy to add the powder on the scoop, when the first scooped-powder amount is less than the second threshold, to acquire the second scooped-powder amount after adjustment. The upward adjustment strategy includes controlling the powder-scooping-and-transferring apparatus to perform a supplementary-scooping operation and/or a re-scooping operation until the scooped-powder amount on the scoop is less than or equal to the first threshold and greater than or equal to the second threshold.

In the embodiment of the disclosure, the current amount of powder to-be-scooped can be regarded as a theoretical amount of powder to-be-scooped during the powder-scooping operation. It can be noted that the current amount of powder to-be-scooped may be less than or equal to a powder weight corresponding to a capacity of the scoop.

The allowable deviation refers to an allowable error in a result recorded by the weighing apparatus. The allowable deviation can be equal to the accuracy of the weighing apparatus. For example, if an accuracy of a balance is 0.1 milligram, the allowable deviation is 0.1 milligram.

If the first scooped-powder amount is less than or equal to the first threshold and greater than or equal to the second threshold, it indicates that the first scooped-powder amount is close to the current amount of powder to-be-scooped and meets an accuracy requirement for the current powder-scooping operation. Therefore, there is no need to adjust the powder on the scoop, and the first scooped-powder amount on the scoop is controlled to remain unadjusted and is taken as the second scooped-powder amount.

If the first scooped-powder amount is greater than the first threshold, it indicates that the first scooped-powder amount is greater than the current amount of powder to-be-scooped with a large difference. In this regard, the powder-scooping-and-transferring apparatus is controlled to implement the downward adjustment strategy to reduce the powder on the scoop. Specifically, the powder-scooping-and-transferring apparatus can be controlled to shake the scoop until the scooped-powder amount on the scoop is less than or equal to the first threshold and greater than or equal to the second threshold, thereby meeting the accuracy requirement for the current powder-scooping operation.

If the first scooped-powder amount is less than the second threshold, it indicates that the first scooped-powder amount is less than the current amount of powder to-be-scooped with a large difference. In this regard, the powder-scooping-and-transferring apparatus is controlled to implement the upward adjustment strategy to add the powder on the scoop. Specifically, the powder-scooping-and-transferring apparatus can be controlled to perform the supplementary-scooping operation and/or the re-scooping operation until the scooped-powder amount on the scoop is less than or equal to the first threshold and greater than or equal to the second threshold, thereby meeting the accuracy requirement for the current powder-scooping operation.

The supplementary-scooping operation refers to further powder-scooping on a basis of previous powder-scooping operation, so as to increase the scooped-powder amount. The re-scooping operation refers to re-performing the powder-scooping operation.

Optionally, the sample-transferring device may control the powder-scooping-and-transferring apparatus to implement the downward adjustment strategy to reduce the powder on the scoop specifically as follows.

The powder-scooping-and-transferring apparatus is controlled to shake the scoop with a first amplitude until the scooped-powder amount on the scoop is less than or equal to the first threshold and greater than or equal to the second threshold, when a difference between the first scooped-powder amount and the first threshold is greater than a third threshold. Alternatively, the powder-scooping-and-transferring apparatus is controlled to shake the scoop with the first amplitude, when the difference between the first scooped-powder amount and the first threshold is greater than the third threshold. The powder-scooping-and-transferring apparatus is controlled to shake the scoop with the second amplitude until the scooped-powder amount on the scoop is less than or equal to the first threshold and greater than or equal to the second threshold, when a difference between the scooped-powder amount on the scoop and the first threshold is greater than 0 and less than or equal to the third threshold. The second amplitude is less than the first amplitude. Alternatively, the powder-scooping-and-transferring apparatus is controlled to shake the scoop with the second amplitude until the scooped-powder amount on the scoop is less than or equal to the first threshold and greater than or equal to the second threshold, when the difference between the first scooped-powder amount and the first threshold is greater than 0 and less than or equal to the third threshold.

In the embodiment of the disclosure, the third threshold is a pre-set value greater than 0, which can be set according to actual needs. For example, the third threshold can be set as 10 mg, 5 mg, 2 mg, 1 mg, or other values.

In a possible embodiment, the powder-scooping-and-transferring apparatus can be controlled to shake the scoop with the first amplitude until the scooped-powder amount on the scoop is less than or equal to the first threshold and greater than or equal to the second threshold, when the difference between the first scooped-powder amount and the first threshold is greater than the third threshold. The first amplitude can be a pre-set default value, a fixed value calculated based on the first scooped-powder amount according to a pre-set formula (such as a linear relationship between the first scooped-powder amount and the first amplitude), or a dynamic value calculated based on the difference between the scooped-powder amount on the scoop and the first threshold according to a pre-set formula (such as a linear relationship between the difference and first amplitude, a proportional integral derivative (PID) algorithm, etc.), which is not limited herein.

In another possible embodiment, when the difference between the first scooped-powder amount and the first threshold is greater than the third threshold, the first scooped-powder amount is significantly different from the current amount of powder to-be-scooped, therefore the scoop is shaken with a greater amplitude (i.e., the first amplitude). After each round of shaking the scoop with the first amplitude, a new m1 recorded by the weighing apparatus can be re-acquired, to calculate a new scooped-powder amount on the scoop. The new scooped-powder amount=m0−new m1. Since the amount of powder on the scoop is decreased after each round of shaking, the new scooped-powder amount is reduced. If a difference between the new scooped-powder amount and the first threshold is still greater than a third threshold, the scoop is continued to be shaken with the first amplitude, and the new scooped-powder amount is calculated by re-acquiring the new m1 recorded by the weighing apparatus. If the difference between the new scooped-powder amount and the first threshold is greater than 0 and less than or equal to the third threshold, the new scooped-powder amount is slightly different from the current amount of powder to-be-scooped. In this regard, the scoop is shaken with a less amplitude (i.e., the second amplitude) until the scooped-powder amount on the scoop is less than or equal to the first threshold and greater than or equal to the second threshold.

In another possible embodiment, when the difference between the first scooped-powder amount and the first threshold is greater than 0 and less than or equal to the third threshold, the first scooped-powder amount is slightly different from the current amount of powder to-be-scooped, and the scoop can be directly shaken with a less amplitude (i.e., the second amplitude). After each round of shaking the scoop with the second amplitude, the new m1 recorded by the weighing apparatus can be re-acquired, to calculate the new scooped-powder amount. The new scooped-powder amount=m0−new m1. Since the amount of powder on the scoop is decreased after each round of shaking, the new scooped-powder amount is reduced, until the new scooped-powder amount is less than or equal to the first threshold and greater than or equal to the second threshold. The second amplitude can be a pre-set default value, a fixed value calculated based on the first scooped-powder amount according to a pre-set formula (such as a linear relationship between the first scooped-powder amount and the second amplitude), or a dynamic value calculated based on the difference between the scooped-powder amount on the scoop and the first threshold according to a pre-set formula (such as a linear relationship between the difference and the second amplitude, the PID algorithm, etc.), which is not limited herein.

Optionally, an amplitude for shaking the scoop is determined by the difference between the scooped-powder amount on the scoop and the first threshold. The difference between the scooped-powder amount on the scoop and the first threshold is positively correlated with the amplitude for shaking the scoop. In the embodiment of the disclosure, at least one of the first amplitude or the second amplitude is determined by the difference between the scooped-powder amount on the scoop and the first threshold, and the amplitude is positively correlated with the difference. For example, the scooped-powder amount on the scoop can be acquired at pre-set time intervals, and when the difference between the scooped-powder amount and the first threshold decreases, the amplitude decreases accordingly.

When shaking the scoop, a single shaking time is fixed (such as 8 ms per time, 10 ms per time, etc.), and a greater amplitude may indicate a faster shaking speed. The number of shaking times per round is also fixed (such as 8 times, 10 times, 12 times, 15 times, 16 times per round, etc.). After one round of shaking is completed, the scooped-powder amount on the scoop can be acquired.

In the embodiment of the disclosure, when the first scooped-powder amount is significantly different from the current amount of powder to-be-scooped, the scoop is shaken with a greater amplitude to quickly reduce the first scooped-powder amount. When the first scooped-powder amount is slightly different from the current amount of powder to-be-scooped, the scoop is shaken with a less amplitude to slowly reduce the first scooped-powder amount until the first scooped-powder amount is less than or equal to the first threshold and greater than or equal to the second threshold. The scooped-powder amount on the scoop can be quickly adjusted to appropriate weight, and the speed and accuracy for adjusting the scooped-powder amount are improved, therefore the efficiency and accuracy for sample-transferring are improved.

Optionally, the sample-transferring device may control the powder-scooping-and-transferring apparatus to implement the downward adjustment strategy to reduce the powder on the scoop specifically as follows. The sample-transferring device controls the powder-scooping-and-transferring apparatus to shake the scoop with the first amplitude. When the difference between weights recorded by the weighing apparatus at multiple adjacent times is less than a set value, the sample-transferring device controls the powder-scooping-and-transferring apparatus to shake the scoop with the second amplitude until the scooped-powder amount on the scoop is less than or equal to the first threshold and greater than or equal to the second threshold. The second amplitude is less than the first amplitude.

In the embodiment of the disclosure, the set value can be pre-set. If the difference between weights recorded by the weighing apparatus at multiple adjacent times is less than the set value, a weight reduced after each shaking of the scoop with the first amplitude is small, and the reading of the weighing apparatus has tended to be stable. In this regard, the scoop can be shaken with a less amplitude (i.e., the second amplitude) for more refined adjustment until the scooped-powder amount on the scoop is less than or equal to the first threshold and greater than or equal to the second threshold, thereby improving the adjustment accuracy of the scooped-powder amount on the scoop.

Optionally, the sample-transferring device may control the powder-scooping-and-transferring apparatus to implement the upward adjustment strategy to add the powder on the scoop specifically as follows.

The sample-transferring device controls the powder-scooping-and-transferring apparatus to perform the supplementary-scooping operation, when a difference between the second threshold and the first scooped-powder amount is less than or equal to a fourth threshold, until the scooped-powder amount on the scoop is less than or equal to the first threshold and greater than or equal to the second threshold.

Alternatively, the sample-transferring device controls the powder-scooping-and-transferring apparatus to perform the re-scooping operation, when the difference between the second threshold and the first scooped-powder amount is greater than the fourth threshold, until the scooped-powder amount on the scoop is less than or equal to the first threshold and greater than or equal to the second threshold.

Alternatively, the sample-transferring device controls the powder-scooping-and-transferring apparatus to perform the re-scooping operation when the difference between the second threshold and the first scooped-powder amount is greater than the fourth threshold. The sample-transferring device controls the powder-scooping-and-transferring apparatus to perform the supplementary-scooping operation, when a difference between the second threshold and the scooped-powder amount on the scoop is less than or equal to the fourth threshold, until the scooped-powder amount on the scoop is less than or equal to the first threshold and greater than or equal to the second threshold.

The fourth threshold is a pre-set value greater than 0, which can be set according to actual needs. For example, the fourth threshold can be set as 10 mg, 15 mg, 18 mg, 20 mg, 25 mg or other values.

When the difference between the second threshold and the first scooped-powder amount is less than or equal to the fourth threshold, a difference between the first scooped-powder amount and the current amount of powder to-be-scooped is relatively small. When the difference between the second threshold and the first scooped-powder amount is greater than the fourth threshold, the difference between the first scooped-powder amount and the current amount of powder to-be-scooped is relatively large.

In the embodiment of the disclosure, the supplementary-scooping operation is applicable to a scenario where the difference between the first scooped-powder amount and the current amount of powder to-be-scooped is relatively small, and the re-scooping operation is applicable to a scenario where the difference between the first scooped-powder amount and the current amount of powder to-be-scooped is relatively large. In the scenario where the difference between the first scooped-powder amount and the current amount of powder to-be-scooped is relatively small, the supplementary-scooping operation is adopted to precisely control an increment of the scooped-powder amount. In the scenario where the difference between the first scooped-powder amount and the current amount of powder to-be-scooped is relatively large, the re-scooping operation is adopted to avoid a situation where a gap between the first scooped-powder amount and the current amount of powder to-be-scooped cannot be quickly narrowed through the supplementary-scooping operation, thereby improving the speed and accuracy for adjusting the first scooped-powder amount, and further improving the efficiency and accuracy for sample transferring.

It can be understood that when the scooped-powder amount on the scoop fails to be less than or equal to the first threshold and greater than or equal to the second threshold after multiple implementations of the adjustment strategy, the scoop can be replaced, and a scoop of more appropriate specification can be used for the powder-scooping operation.

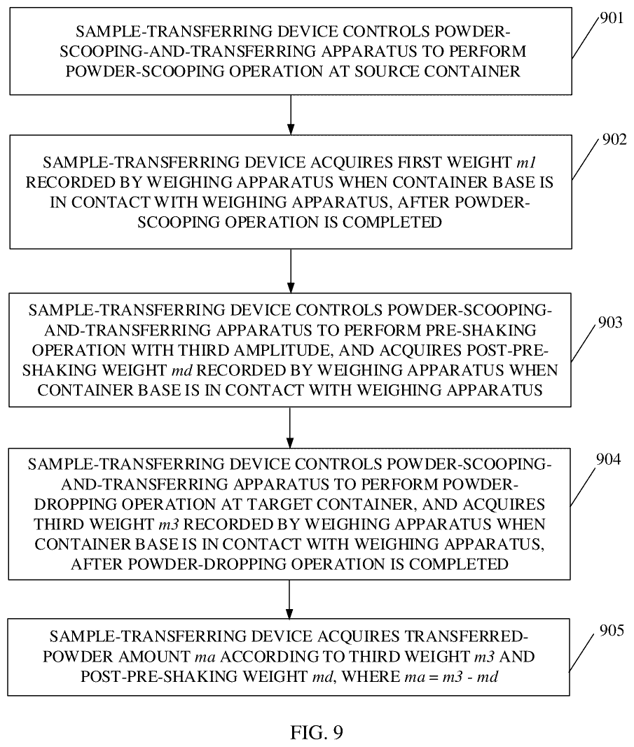

Reference can be made to FIG. 9, where FIG. 9 is a schematic flow chart of another method for transferring the powder sample provided in the embodiment of the disclosure. As illustrated in FIG. 9, the method may include the following operations.

At 901, the sample-transferring device controls the powder-scooping-and-transferring apparatus to perform the powder-scooping operation at the source container.

At 902, the sample-transferring device acquires the first weight m1 recorded by the weighing apparatus when the container base is in contact with the weighing apparatus, after the powder-scooping operation is completed.

For specific implementations of operations 901 to 902, reference can be made to detailed descriptions of foregoing operations at 301 and 302 or operations at 402 and 403, which will not be repeated herein.

At 903, the sample-transferring device controls the powder-scooping-and-transferring apparatus to perform a pre-shaking operation with a third amplitude, and acquires a post-pre-shaking weight md recorded by the weighing apparatus when the container base is in contact with the weighing apparatus.

In the embodiment of the disclosure, the pre-shaking operation can be performed for one round according to a pre-set amplitude. The pre-shaking operation can make the powder on the scoop of the powder-scooping-and-transferring apparatus more stable, and during the movement of the powder-scooping-and-transferring apparatus, the powder on the scoop is less possibly to spill, therefore the accuracy for transferring the powder sample is improved. The third amplitude can be a pre-set default value.

At 904, the sample-transferring device controls the powder-scooping-and-transferring apparatus to perform the powder-dropping operation at the target container, and acquires the third weight m3 recorded by the weighing apparatus when the container base is in contact with the weighing apparatus, after the powder-dropping operation is completed.

For specific implementations of operations at 904, reference can be made to detailed description of foregoing operations at 303, which will not be repeated herein.

At 905, the sample-transferring device acquires the transferred-powder amount ma according to the third weight m3 and the post-pre-shaking weight md, where ma=m3−md.

In the embodiment of the disclosure, the powder-scooping-and-transferring apparatus can be controlled to perform the powder-scooping operation at the source container. After the powder-scooping operation is completed, the powder-scooping-and-transferring apparatus is controlled to perform the pre-shaking operation, and then the powder is transferred from the source container into the target container. Automated transfer of the powder sample can be implemented on the basis of foregoing. Compared with manual dispensing, the labor cost is reduced, and the efficiency for transferring the powder sample is improved. The pre-shaking operation can make the powder on the scoop of the powder-scooping-and-transferring apparatus more stable, and during the movement of the powder-scooping-and-transferring apparatus, the powder on the scoop is less possibly to spill, therefore the accuracy for transferring the powder sample is improved.

It can be understood that the pre-shaking operation can be performed after operations at 902 are executed, that is, first scoop the powder, then weigh, then pre-shake and weigh at the same time. Alternatively, the pre-shaking operation can be performed before operations at 902 are executed, that is, first scoop the powder, then pre-shake, then weigh. The disclosure is not limit in this regard.

After operations at 903 are executed and the pre-shaking operation is completed, a stabilized scooped-powder amount on the scoop ms can be acquired by the weight increment method, where ms=m0−md, and the scooped-powder amount can be used to update the first scooped-powder amount in operations at 804 and 805 in aforementioned embodiments.

Optionally, prior to executing operations at 301, 402, 501, 601, 702, 802, or 901, the following operations can also be executed. The sample-transferring device performs a flattening operation on the powder sample in the source container to make the powder sample in the source container reach a flat state.

The flattening operation can be shaking or vibrating the source container to make the powder sample in the source container reach the flat state, thereby facilitating subsequent powder-scooping operations. The flattening operation can be implemented through the powder-scooping-and-transferring apparatus or a vibrating-and-flattening apparatus. For example, the sample-transferring device can send corresponding control instructions to the powder-scooping-and-transferring apparatus to make the powder-scooping-and-transferring apparatus shake or vibrate the source container (exemplarily, the powder-scooping-and-transferring apparatus is controlled to tap a wall of the source container, so as to make the source container shake or vibrate), so that the powder sample in the source container reaches the flat state. For another example, the source container can be placed on the vibrating-and-flattening apparatus, or the source container can be in contact with or get close to the vibrating-and-flattening apparatus, and the sample-transferring device can send the corresponding control instructions to the vibrating-and-flattening apparatus, so as to make the vibrating-and-flattening apparatus shake or vibrate the source container, so that the powder sample in the source container reaches the flat state.

Optionally, the powder-scooping-and-transferring apparatus has the scoop. The sample-transferring device may perform the flattening operation on the powder sample in the source container specifically as follows. The sample-transferring device controls the scoop to reach into the source container and be in contact with or get close to an inner wall of the source container, and controls the powder-scooping-and-transferring apparatus to shake the scoop to drive the source container to shake.

In the embodiment of the disclosure, when the scoop is in contact with or get close to the inner wall of the source container, the powder-scooping-and-transferring apparatus can be controlled to shake the scoop, thereby driving the source container to shake, so that the powder sample in the source container reaches the flat state. Flattening the powder facilitates the visual detection apparatus to collect the powder distribution in the source container accurately, and also facilitates the scoop to probe the powder in combination with the weighing apparatus, to improve the accuracy of the powder-scooping reference position, thereby being more conducive to the powder-scooping operation.

Optionally, the powder-scooping system further includes the vibrating-and-flattening apparatus. The sample-transferring device may perform the flattening operation on the powder sample in the source container specifically as follows. The sample-transferring device makes the vibrating-and-flattening apparatus be in contact with or get close to an outer wall of the source container, and controls the vibrating-and-flattening apparatus to start to vibrate the source container.

In the embodiment of the disclosure, the vibrating-and-flattening apparatus may include a vibrating-and-flattening driving member and an execution member. The execution member is in contact with or gets close to the outer wall of the source container. The vibrating-and-flattening driving member may include at least one of a rotating motor, or a vibration motor, etc., and the execution member may include at least one of a cam, a beating rod, or a whip, etc. When the vibrating-and-flattening driving member is the rotating motor, the execution member can be configured as the cam, the beating rod, the whip, or other structures. The vibrating-and-flattening driving member drives the execution member to swing or rotate, so that the execution member beats or taps the outer wall of the source container, and the powder sample in the source container reaches the flat state.

Optionally, the target container is disposed on the container base in a first direction, and the source container is disposed on the container base in a second direction, and the first direction intersects with the second direction.

In the embodiment of the disclosure, as illustrated in FIG. 1, the first direction intersects with the second direction, which can facilitate the powder-scooping-and-transferring apparatus to transfer the powder sample from the source container into the target container.

Optionally, the first direction is a vertical direction. In the first direction, an opening of the source container exceeds a bottom of the source container and faces towards the target container, and the opening of the source container exceeds the opening of the target container.

In the embodiment of the disclosure, as illustrated in FIG. 1, the first direction is the vertical direction, and the target container is placed vertically, which can ensure that the powder in the target container is not spilled out and is convenient for powder-dropping.

The opening of the source container exceeds the bottom of the source container, which can ensure that the powder in the source container is not spilled out. The opening of the source container faces towards the target container and exceeds the opening of the target container, which can facilitate the powder-scooping-and-transferring apparatus to transfer the powder sample from the source container into the target container and improve the efficiency for transferring the powder sample.

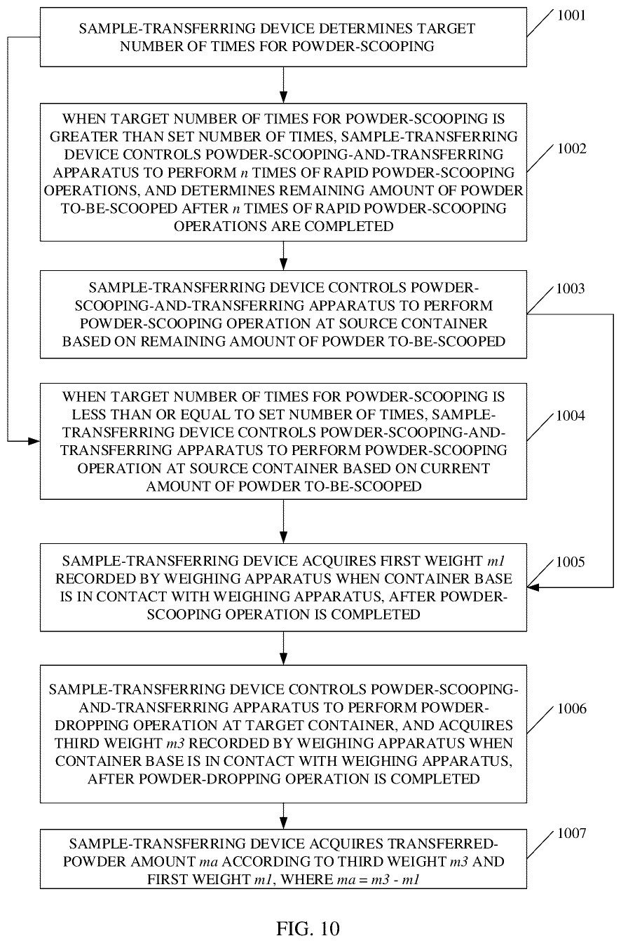

Reference can be made to FIG. 10, where FIG. 10 is a schematic flow chart of another method for transferring the powder sample provided in the embodiment of the disclosure. As illustrated in FIG. 10, the method may include the following operations.

At 1001, the sample-transferring device determines a target number of times for powder-scooping.

The target number of times for powder-scooping can be determined based on the scooped-powder amount on the scoop and a target amount of powder to-be-scooped. The scooped-powder amount on the scoop is related to a specification of the scoop and/or the physical property of the powder (for example, the density, the hardness, and the particle size of the powder). The target amount of powder to-be-scooped is a total amount of powder that needs to be transferred from the source container into the target container.

A target number of times for powder-scooping P can be rounded up or down, where P=(target amount of powder to-be-scooped/scooped-powder amount on the scoop). The transferred-powder amount ma in the aforementioned embodiments can be used as the scooped-powder amount on the scoop, or a difference between weights recorded by the weighing apparatus before and after one powder-scooping operation can be used as the scooped-powder amount on the scoop, or an average value of differences between weights recorded by the weighing apparatus before and after N times of powder-scooping operations can be used as the scooped-powder amount on the scoop, or an average value of previous scooped-powder amounts on the scoop can be used as the scooped-powder amount on the scoop. The embodiments of the disclosure are not limited in this regard.

Optionally, the sample-transferring device may determine the target number of times for powder-scooping specifically as follows. The sample-transferring device determines the target number of times for powder-scooping based on the transferred-powder amount ma and the target amount of powder to-be-scooped. Alternatively, the sample-transferring device determines the target number of times for powder-scooping based on the capacity of the scoop and the target amount of powder to-be-scooped.

In the embodiment of the disclosure, a target number of times for powder-scooping P can be rounded up or down, where P=(target amount of powder to-be-scooped/ma); or, P=(target amount of powder to-be-scooped/mz). mz represents the capacity of the scoop. Exemplarily, the capacity of the scoop can be in milligrams (mg) or grams (g), such as 50 mg, 100 mg, 500 mg, 1 g, 2 g, etc. Alternatively, mz is a powder amount determined based on the capacity of the scoop and the physical property of the powder. Exemplarily, a capacity of the scoop is A ml, and a density of the powder sample is B milligrams per cubic centimeter (mg/cm³), then mz=A*B, where “*” represents multiplication. For example, a capacity of the scoop is 1 ml and a density of the powder is 4 mg/cm³, then mz is 4 mg.

Determining the target number of times for powder-scooping based on the transferred-powder amount ma and the target amount of powder to-be-scooped means that after a standard powder-scooping operation is completed (reference can be made to operations at 301 to 304 in the aforementioned embodiments), the target number of times for powder-scooping can be determined based on an acquired actual transferred-powder amount, which can improve the accuracy of acquiring the target number of times for powder-scooping. Determining the target number of times for powder-scooping based on the capacity of the scoop and the target amount of powder to-be-scooped means that there is no need to perform the standard powder-scooping operation, and the target number of times for powder-scooping can be quickly determined through the capacity of the scoop.

At 1002, when the target number of times for powder-scooping is greater than a set number of times, the sample-transferring device controls the powder-scooping-and-transferring apparatus to perform n times of rapid powder-scooping operations, and determines a remaining amount of powder to-be-scooped after n times of rapid powder-scooping operations are completed.

The set number of times can be set according to actual needs, such as 3 times, 4 times, 5 times, etc. The rapid powder-scooping operation includes controlling the powder-scooping-and-transferring apparatus to scoop the powder from the source container and directly drop the scooped-powder into the target container when the container base is not in contact with the weighing apparatus, where n is less than the target number of times for powder-scooping.

The rapid powder-scooping operation does not require acquiring the weight recorded by the weighing apparatus during powder-scooping, which can improve the efficiency of powder-scooping. The number of rapid powder-scooping operations n is less than the target number of times for powder-scooping, which can ensure that after performing n times of rapid powder-scooping operations, a total amount of scooped-powder during n times of rapid powder-scooping operations does not exceed the target amount of powder to-be-scooped, thereby improving the accuracy for powder-scooping. n can be determined based on the target number of times for powder-scooping. For example, if one standard powder-scooping operation has been performed prior to determining the target number of times for powder-scooping, n can be (target number of times for powder-scooping−2); if no standard powder-scooping operation has been performed prior to determining the target number of times for powder-scooping, n can be (target number of times for powder-scooping−1). n can also be determined based on the target number of times for powder-scooping and the set number of times. For example, n=(target number of times for powder-scooping−set number of times), or n=(target number of times for powder-scooping−set number of times−1).

At 1003, the sample-transferring device controls the powder-scooping-and-transferring apparatus to perform the powder-scooping operation at the source container based on the remaining amount of powder to-be-scooped.

The remaining amount of powder to-be-scooped can be regarded as a difference between the target amount of powder to-be-scooped and the total amount of scooped-powder during n times of rapid powder-scooping operations. Alternatively, the remaining amount of powder to-be-scooped can be regarded as a difference between the target amount of powder to-be-scooped and a sum of the total amount of scooped-powder during n times of rapid powder-scooping operations and the transferred-powder amount in one standard powder-scooping operation. After n times of rapid powder-scooping operations are completed, the total amount of scooped-powder during n times rapid powder-scooping operations can be acquired by weighing through the weighing apparatus, or can be acquired by summing up the scooped-powder amount on the scoop from each rapid powder-scooping operation, as estimated by the visual detection apparatus.

After operations at 1003 are executed, operations at 1005 to 1007 are executed until the transferred-powder amount is within a range of (remaining amount of powder to-be-scooped±allowable deviation). When the transferred-powder amount in one operation is out of the range of (remaining amount of powder to-be-scooped±allowable deviation), operations at 1003 and operations at 1005 to 1007 can be executed for multiple times until the transferred-powder amount in one operation is within the range.

At 1004, when the target number of times for powder-scooping is less than or equal to the set number of times, the sample-transferring device controls the powder-scooping-and-transferring apparatus to perform the powder-scooping operation at the source container based on the current amount of powder to-be-scooped.

After operations at 1004 are executed, operations at 1005 to 1007 are executed. When the current amount of powder to-be-scooped is less than the target amount of powder to-be-scooped, operations at 1004 to 1007 can be executed for multiple times until a total transferred-powder amount is within the range of (target amount of powder to-be-scooped±allowable deviation).

At 1005, the sample-transferring device acquires the first weight m1 recorded by the weighing apparatus when the container base is in contact with the weighing apparatus, after the powder-scooping operation is completed.

At 1006, the sample-transferring device controls the powder-scooping-and-transferring apparatus to perform the powder-dropping operation at the target container, and acquires the third weight m3 recorded by the weighing apparatus when the container base is in contact with the weighing apparatus, after the powder-dropping operation is completed.

At 1007, the sample-transferring device acquires the transferred-powder amount ma according to the third weight m3 and the first weight m1, where ma=m3−m1.

For specific implementations of operations AT 1005 to 1007, reference can be made to relevant descriptions of foregoing embodiments, which will not be repeated herein.

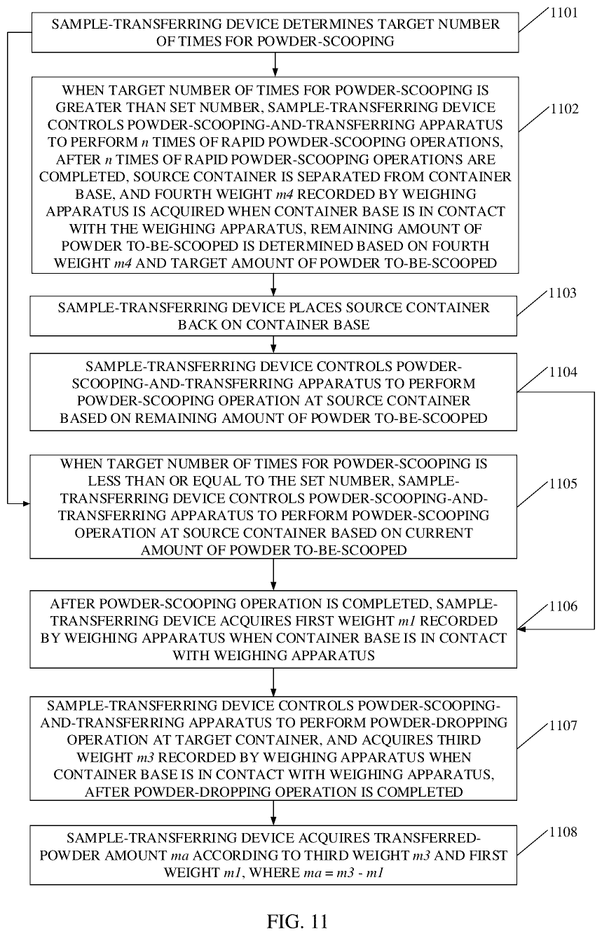

Reference can be made to FIG. 11, where FIG. 11 is a schematic flow chart of yet another method for transferring the powder sample provided in the embodiment of the disclosure. As illustrated in FIG. 11, the method may include the following operations.

At 1101, the sample-transferring device determines the target number of times for powder-scooping.

At 1102, when the target number of times for powder-scooping is greater than a set number, the sample-transferring device controls the powder-scooping-and-transferring apparatus to perform n times of rapid powder-scooping operations. After n times of rapid powder-scooping operations are completed, the source container is separated from the container base, and a fourth weight m4 recorded by the weighing apparatus is acquired when the container base is in contact with the weighing apparatus. The remaining amount of powder to-be-scooped is determined based on the fourth weight m4 and the target amount of powder to-be-scooped.

In one example, if no standard powder-scooping operation has been performed prior to performing n times of rapid powder-scooping operations, the remaining amount of powder to-be-scooped=target amount of powder to-be-scooped−(m4−m0′); where m0′ is a weight recorded by the weighing apparatus, and is acquired by the sample-transferring device when the source container is separated from the container base and the container base is in contact with the weighing apparatus, prior to n times of rapid powder-scooping operations. In this regard, m0′ can be regarded as a sum of weights of the container base and the empty target container, m4 can be regarded as a sum of the weight of the container base, the weight of the target container, and a total transferred-powder amount during n times of rapid powder-scooping operations, and (m4−m0′) is the total transferred-powder amount during n times of rapid powder-scooping operations, i.e., the total transferred-powder amount in the target container.

In another example, if one standard powder-scooping operation has been performed before performing n times of rapid powder-scooping operations, the remaining amount of powder to-be-scooped=target amount of powder to-be-scooped−(m4−m0′+ma). In this regard, m0′ can be regarded as a sum of the weight of the container base, the weight of the target container, and the transferred-powder amount ma of one standard powder-scooping operation; m4 can be regarded as the sum of the weight of the container base, the weight of the target container, the transferred-powder amount ma of one standard powder-scooping operation, and the total transferred-powder amount during n times of rapid powder-scooping operations; (m4−m0′+ma) is the sum of the transferred-powder amount ma of one standard powder-scooping operation and the total transferred-powder amount during n times of rapid powder-scooping operations, i.e., the total transferred-powder amount in the target container.

The weight of the container base and the weight of the empty target container can be acquired by weighing before the powder-scooping operation, or can be manually input, or can be pre-stored and directly callable, which is not limited herein.

When the weight of the container base and the weight of the target container are acquired by weighing, before operations at 1102 are executed, the following operations may also be executed. The source container is separated from the container base, and the weight m0′ recorded by the weighing apparatus is acquired when the container base is in contact with the weighing apparatus.

Correspondingly, the remaining amount of powder to-be-scooped may be determined based on the fourth weight m4 and the target amount of powder to-be-scooped specifically as follows. The remaining amount of powder to-be-scooped is determined based on the fourth weight m4, m0′, and the target amount of powder to-be-scooped.

At 1103, the sample-transferring device places the source container back on the container base.

At 1104, the sample-transferring device controls the powder-scooping-and-transferring apparatus to perform the powder-scooping operation at the source container based on the remaining amount of powder to-be-scooped.

After operations at 1104 are executed, operations at 1106 to 1108 are executed.

At 1105, when the target number of times for powder-scooping is less than or equal to the set number, the sample-transferring device controls the powder-scooping-and-transferring apparatus to perform the powder-scooping operation at the source container based on the current amount of powder to-be-scooped.

After operations at 1105 are executed, operations at 1106 to 1108 are executed.

At 1106, after the powder-scooping operation is completed, the sample-transferring device acquires the first weight m1 recorded by the weighing apparatus when the container base is in contact with the weighing apparatus.

At 1107, the sample-transferring device controls the powder-scooping-and-transferring apparatus to perform the powder-dropping operation at the target container, and acquires the third weight m3 recorded by the weighing apparatus when the container base is in contact with the weighing apparatus, after the powder-dropping operation is completed.

At 1108, the sample-transferring device acquires the transferred-powder amount ma according to the third weight m3 and the first weight m1, where ma=m3−m1.

For specific implementations of operations 1106 to 1108, reference can be made to the relevant descriptions of the aforementioned embodiments, which will not be repeated herein.

An entire automatic process for transferring powder sample is described below with reference to FIG. 1 and FIG. 2.

Loading (the source container 14 containing powder and the empty target container 15 are placed manually or mechanically, and the container base 12 is separated from the weighing apparatus 11 initially).→The container base 12 comes into contact with the weighing apparatus 11 to acquire the initial weight m0.→The container base 12 is separated from the weighing apparatus 11 after the powder-scooping starting position is determined.→A powder-scooping manipulator 17 drives the scoop 16 to scoop the powder from the source container 14.→The container base 12 is in contact with the weighing apparatus 11, a post-powder-scooping weight m1 is acquired after the powder is scooped, and a scooped-powder amount ms is acquired by the weight reduction method, where ms=m0−m1.→The container base 12 is kept to be in contact with the weighing apparatus 11, the scoop 16 moves to an opening of the target container 15, a weight m2 is acquired after the scoop 16 moves to the opening, and a powder loss mw during transferring is acquired by a weight increment method, where mw=m2−m1.→The container base 12 is kept to be in contact with the weighing apparatus 11, and the scoop 16 drops the powder.→A post-powder-dropping weight m3 is acquired after the powder is dropped, and the actual transferred-powder amount is acquired by the weight increment method, where ma=m3−m2.

The hardware configuration includes the weighing apparatus 11, the container base 12, the moving apparatus 19, and the powder-scooping manipulator 17 with the scoop 16. Both the target container 15 and the source container 14 can be placed on the container base 12 at the same time. The moving apparatus 19 is used for moving the container base 12, to make the container base 12 be in contact with or separate from the weighing apparatus 11. The weighing apparatus 11 is used for weighing. The powder-scooping manipulator 17 is used for controlling the scoop 16 to transfer the powder from the source container 14 to the target container 15.

First weighing: the moving apparatus 19 drives the container base 12 to lower, thereby placing the container base 12 on the weighing apparatus 11 to acquire the initial weight m0.

Second weighing: the moving apparatus 19 drives the container base 12 to lift, thereby separating the container base 12 from the weighing apparatus 11. The powder-scooping manipulator 17 drives the scoop 16 to scoop the powder from the source container 14. The moving apparatus 19 places the container base 12 on the weighing apparatus 11 again after powder-scooping, to acquire the post-powder-scooping weight m1. The scooped-powder amount ms is acquired by the weight reduction method, where ms=m0−m1.

Third weighing: the container base 12 is kept in contact with the weighing apparatus 11, the powder-scooping manipulator 17 drives the scoop 16 to move to the opening of the target container 15, and the weight m2 is acquired after moving to the opening. The powder loss mw during transferring is acquired by the weight increment method, where mw=m2−m1.

Fourth weighing: the container base 12 is kept in contact with the weighing apparatus 11, the scoop 16 drops the powder. The post-powder-dropping weight m3 is acquired after powder-dropping. The actual transferred-powder amount is acquired by the weight increment method, where ma=m3−m2.

When the scooped-powder amount ms is greater than the first threshold, the downward adjustment strategy is implemented, as detailed in the foregoing operations. When the scooped-powder amount ms is less than the second threshold, the upward adjustment strategy is implemented, as detailed in the foregoing operations.

In the embodiment of the disclosure, the visual prediction model can be used to predict the scooped-powder amount on the scoop. Further, deviation can be calculated using a visually-predicted scooped-powder amount and an actually-weighed scooped-powder amount. The powder amount predicted by the visual prediction model can be compensated based on the deviation, to improve prediction accuracy of subsequent visual prediction model. A powder distribution on the scoop and the actually-weighed scooped-powder amount can be used as new training samples to fine-tune the visual prediction model, thereby improving the prediction accuracy of the visual prediction model.

If a target amount of powder to-be-scooped that needs to be transferred is large, performing the foregoing process of automated transfer of the powder sample for multiple times may result in low efficiency of powder transfer. After completing the first powder transfer according to the foregoing process of automated transfer of the powder sample, the transferred-powder amount and the powder loss during transferring are acquired. A required number of times for powder-scooping (i.e., the target number of times for powder-scooping) is calculated based on the transferred-powder amount in one operation and the target amount of powder to-be-scooped. If the number of times is greater than a set number (such as 3 times), perform n times of rapid powder-scooping operations (for example, instead of using the weighing apparatus 11 for weighing, the visual prediction model is used for estimating and weighing, or the transferred-powder amount each time is defaulted as the transferred-powder amount of the first powder transfer, or is defaulted as a previous empirical value, etc.). When approaching the target amount of powder to-be-scooped or a remaining number of times for powder-scooping is less than or equal to the set number, remove the source container 14 and make the container base 12 be in contact with the weighing apparatus 11, and perform weighing to determine a difference between a current amount of powder on the target container 15 (the target container 15 is initially an empty vessel) and the target amount of powder to-be-scooped. The source container 14 is placed back, a powder amount to-be-scooped for next powder-scooping operation (standard powder-scooping operation) is calculated based on this difference, and next process of powder transfer is executed.

The embodiment of the disclosure provides a control for transferring the powder sample based on the weight reduction method and the weight increment method, which can replace manual work to complete automated powder dispensing, and can improve transfer accuracy and transfer efficiency.

The foregoing describes the solutions of the embodiments of the disclosure mainly from an aspect of a process executed on a method side. It can be understood that, in order to implement the foregoing functions, the sample-transferring device includes corresponding hardware structures and/or software modules for executing various functions. Those of ordinary skill in the art can be easily aware that, in combination with the units and algorithm steps of each example described in the embodiments provided in the disclosure, the disclosure may be implemented by hardware or a combination of hardware and computer software. Whether a certain function is executed by means of hardware or computer software to drive the hardware depends on specific applications and design constraint conditions of the technical solutions. Those of ordinary skill in the art may use different methods to implement the described functions for each specific application, but the implementation shall not be considered as going beyond the scope of the disclosure.

Embodiments of the disclosure may divide functional units of a sample-transferring device according to the foregoing method examples. For example, functional units may be divided corresponding to respective functions, or two or more functions may be integrated into one processing unit. The integrated unit may be implemented in a form of hardware, and may also be implemented in a form of a software functional unit. It can be noted that the division of the units in the embodiments of the disclosure is schematic, which is merely logical function division and may be other division in actual implementation.

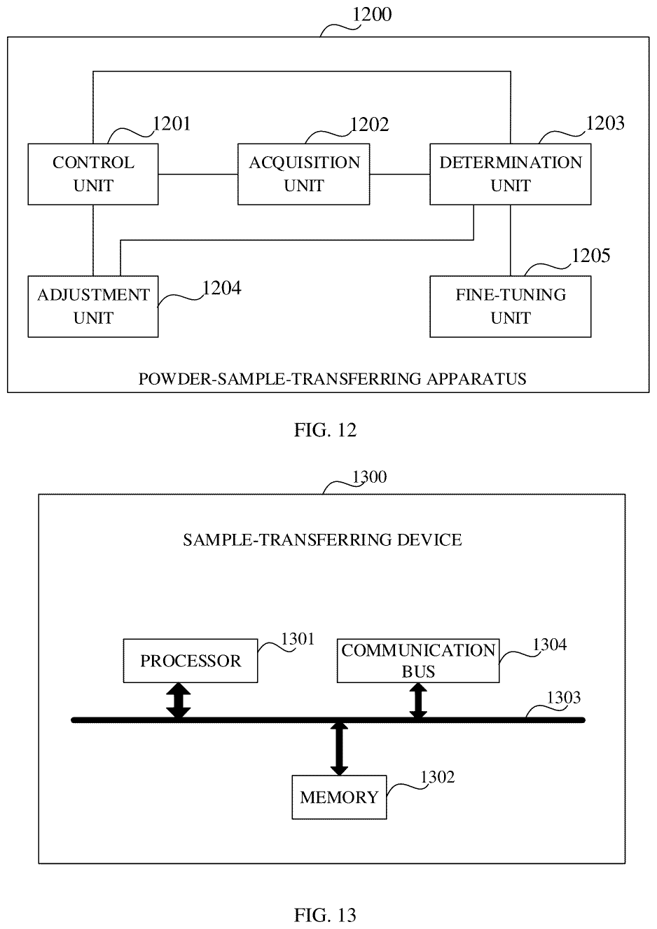

Reference can be made to FIG. 12, where FIG. 12 is a schematic structural diagram of a powder-sample-transferring apparatus provided in an embodiment of the disclosure. The powder-sample-transferring apparatus is applicable to a powder-scooping system. The powder-scooping system includes a weighing apparatus, a container base, and a powder-scooping-and-transferring apparatus. The container base is used to place a source container and a target container. The weighing apparatus is located below the container base and is used to weigh the container base when the weighing apparatus is in contact with the container base. The powder-scooping-and-transferring apparatus is used to scoop powder from the source container and transfer scooped powder to the target container. As illustrated in FIG. 12, the powder-sample-transferring apparatus 1200 includes a control unit 1201, an acquisition unit 1202, and a determination unit 1203.

The control unit 1201 is configured to control the powder-scooping-and-transferring apparatus to perform a powder-scooping operation at the source container.

The acquisition unit 1202 is configured to acquire a first weight m1 recorded by the weighing apparatus when the container base is in contact with the weighing apparatus, after the powder-scooping operation is completed.

The control unit 1201 is further configured to control the powder-scooping-and-transferring apparatus to perform a powder-dropping operation at the target container.

The acquisition unit 1202 is further configured to acquire a third weight m3 recorded by the weighing apparatus when the container base is in contact with the weighing apparatus, after the powder-dropping operation is completed.

The determination unit 1203 is configured to acquire a transferred-powder amount ma according to the third weight m3 and the first weight m1, where ma=m3−m1.

Optionally, in terms of controlling the powder-scooping-and-transferring apparatus to perform the powder-scooping operation at the source container, the control unit 1201 is configured to determine a powder-scooping reference position in the source container, and control the powder-scooping-and-transferring apparatus to perform the powder-scooping operation at the source container according to the powder-scooping reference position.

Optionally, the acquisition unit 1202 is further configured to acquire an initial weight m0 recorded by the weighing apparatus when the container base is in contact with the weighing apparatus before the control unit 1201 determines the powder-scooping reference position in the source container.

In terms of determining the powder-scooping reference position in the source container, the control unit 1201 is configured to: control the powder-scooping-and-transferring apparatus to move to a fixed position to perform the powder-scooping operation, and acquire a weight m0′ recorded by the weighing apparatus; determine the fixed position as a powder-scooping starting position in the source container, if m0′ is less than m0; control the powder-scooping-and-transferring apparatus to move to a next position according to a set step-length and a set direction, to perform the powder-scooping operation until m0′ is less than m0, if m0′ is equal to m0, and determine a position reached by a last movement as the powder-scooping starting position in the source container; and determine the powder-scooping reference position in the source container based on the powder-scooping starting position.

Optionally, the powder-scooping system further includes a visual detection apparatus. In terms of determining the powder-scooping reference position in the source container, the control unit 1201 is configured to collect a powder distribution of the powder sample in the source container using the visual detection apparatus; determine the powder-scooping starting position in the source container according to the powder distribution of the powder sample in the source container; and determine the powder-scooping reference position in the source container based on the powder-scooping starting position.

Optionally, the visual detection apparatus includes a top visual acquisition module and a side visual acquisition module. In terms of collecting the powder distribution of the powder sample in the source container using the visual detection apparatus, the control unit 1201 is configured to photograph the source container from top using the top visual acquisition module, and input an acquired image in a top view into a first visual model to acquire a powder profile in the top view; photograph the source container from side using the side visual acquisition module, and input an acquired side image in a side view into a second visual model to acquire a powder profile in the side view; and perform a three-dimensional fusion on the powder profile in the top view and the powder profile in the side view to acquire the powder distribution of the powder sample in the source container.

Optionally, in terms of determining the powder-scooping reference position in the source container based on the powder-scooping starting position, the control unit 1201 is configured to acquire a physical property parameter of the powder sample in the source container; determine a corresponding powder-scooping offset according to the physical property parameters of the powder sample; and determine the powder-scooping reference position in the source container based on the powder-scooping starting position and the corresponding powder-scooping offset.

Optionally, in terms of determining controlling the powder-scooping-and-transferring apparatus to perform the powder-scooping operation at the source container according to the powder-scooping reference position, the control unit 1201 is configured to control the powder-scooping-and-transferring apparatus to move to the powder-scooping reference position, and perform the powder-scooping operation according to a set powder-scooping movement, where the set powder-scooping movement is determined based on at least one of an amount of powder in the source container, a current amount of powder to-be-scooped, or the physical property parameter of the powder sample.

Optionally, the powder-sample-transferring apparatus 1200 further includes an adjustment unit 1204. The powder-scooping-and-transferring apparatus has a scoop. The determination unit 1203 is further configured to determine a first scooped-powder amount on the scoop after the powder-scooping operation is completed.

The adjustment unit 1204 is configured to control the powder-scooping-and-transferring apparatus to adjust the powder on the scoop according to the first scooped-powder amount and the current amount of powder to-be-scooped, to acquire a second scooped-powder amount after adjustment.

In terms of controlling the powder-scooping-and-transferring apparatus to perform the powder-dropping operation at the target container, the control unit 1201 is configured to control the powder-scooping-and-transferring apparatus to perform the powder-dropping operation at the target container based on the second scooped-powder amount.

Optionally, the powder-scooping system further includes the visual detection apparatus. In terms of determining the first scooped-powder amount on the scoop, the determination unit 1203 is configured to collect the powder distribution on the scoop with the visual detection apparatus; and determine the first scooped-powder amount on the scoop based on the powder distribution and a visual prediction model. The visual prediction model is used to reflect corresponding relationships between different powder distributions and powder amounts.

Optionally, the powder-sample-transferring apparatus 1200 further includes a fine-tuning unit 1205.

The acquisition unit 1202 is further configured to acquire the initial weight m0 recorded by the weighing apparatus when the container base is in contact with the weighing apparatus.

The determination unit 1203 is further configured to acquire an actual scooped-powder amount on the scoop according to the initial weight m0 and the first weight m1.

The fine-tuning unit 1205 is configured to calculate a deviation between the actual scooped-powder amount and the first scooped-powder amount, and fine-tunes the visual prediction model based on the deviation to acquire a new visual prediction model.

Optionally, the acquisition unit 1202 is further configured to acquire the initial weight m0 recorded by the weighing apparatus when the container base is in contact with the weighing apparatus.

In terms of determining the first scooped-powder amount on the scoop, the determination unit 1203 is configured to acquire the first scooped-powder amount on the scoop according to the initial weight m0 and the first weight m1.

Optionally, in terms of controlling the powder-scooping-and-transferring apparatus to adjust the powder on the scoop according to the first scooped-powder amount and the current amount of powder to-be-scooped to acquire the second scooped-powder amount after adjustment, the adjustment unit 1204 is configured to perform the following operations.

When the first scooped-powder amount is less than or equal to a first threshold and greater than or equal to a second threshold, the first scooped-powder amount on the scoop to is remain unadjusted, and the first scooped-powder amount is taken as the second scooped-powder amount. The first threshold is equal to a sum of the current amount of powder to-be-scooped and an allowable deviation, and the second threshold is equal to a difference between the current amount of powder to-be-scooped and the allowable deviation.

When the first scooped-powder amount is greater than the first threshold, the powder-scooping-and-transferring apparatus is controlled to implement a downward adjustment strategy to reduce the powder on the scoop, to acquire the second scooped-powder amount after adjustment. The downward adjustment strategy includes controlling the powder-scooping-and-transferring apparatus to shake the scoop until the scooped-powder amount on the scoop is less than or equal to the first threshold and greater than or equal to the second threshold.

When the first scooped-powder amount is less than the second threshold, the powder-scooping-and-transferring apparatus is controlled to implement an upward adjustment strategy to add the powder on the scoop, to acquire the second scooped-powder amount after adjustment. The upward adjustment strategy includes controlling the powder-scooping-and-transferring apparatus to perform a supplementary-scooping operation and/or a re-scooping operation until the scooped-powder amount on the scoop is less than or equal to the first threshold and greater than or equal to the second threshold.

Optionally, in terms of controlling the powder-scooping-and-transferring apparatus to implement the downward adjustment strategy to reduce the powder on the scoop, the adjustment unit 1204 is configured to perform the following operations.

When a difference between the first scooped-powder amount and the first threshold is greater than a third threshold, the powder-scooping-and-transferring apparatus is controlled to shake the scoop with a first amplitude until the scooped-powder amount on the scoop is less than or equal to the first threshold and greater than or equal to the second threshold.

Alternatively, when the difference between the first scooped-powder amount and the first threshold is greater than the third threshold, the powder-scooping-and-transferring apparatus is controlled to shake the scoop with the first amplitude; when a difference between the scooped-powder amount on the scoop and the first threshold is greater than 0 and less than or equal to the third threshold, the powder-scooping-and-transferring apparatus is controlled to shake the scoop with a second amplitude until the scooped-powder amount on the scoop is less than or equal to the first threshold and greater than or equal to the second threshold. The second amplitude is less than the first amplitude.

Alternatively, when the difference between the first scooped-powder amount and the first threshold is greater than 0 and less than or equal to the third threshold, the powder-scooping-and-transferring apparatus is controlled to shake the scoop with the second amplitude until the scooped-powder amount on the scoop is less than or equal to the first threshold and greater than or equal to the second threshold.

Optionally, an amplitude for shaking the scoop is determined by the difference between the scooped-powder amount on the scoop and the first threshold, and the difference between the scooped-powder amount on the scoop and the first threshold is positively correlated with the amplitude for shaking the scoop.

Optionally, in terms of controlling the powder-scooping-and-transferring apparatus to implement the downward adjustment strategy to reduce the powder on the scoop, the adjustment unit 1204 is configured to control the powder-scooping-and-transferring apparatus to shake the scoop with the first amplitude; and when a difference between weights recorded by the weighing apparatus at multiple adjacent times is less than a set value, control the powder-scooping-and-transferring apparatus to shake the scoop with the second amplitude until the scooped-powder amount on the scoop is less than or equal to the first threshold and greater than or equal to the second threshold. The second amplitude is less than the first amplitude.

Optionally, in terms of controlling the powder-scooping-and-transferring apparatus to implement the upward adjustment strategy to add the powder on the scoop, the adjustment unit 1204 is configured to perform the following operations.

When a difference between the second threshold and the first scooped-powder amount is less than or equal to a fourth threshold, the powder-scooping-and-transferring apparatus is controlled to perform the supplementary-scooping operation until the scooped-powder amount on the scoop is less than or equal to the first threshold and greater than or equal to the second threshold.

Alternatively, when the difference between the second threshold and the first scooped-powder amount is greater than the fourth threshold, the powder-scooping-and-transferring apparatus is controlled to perform the re-scooping operation until the scooped-powder amount on the scoop is less than or equal to the first threshold and greater than or equal to the second threshold.

Alternatively, when the difference between the second threshold and the first scooped-powder amount is greater than the fourth threshold, the adjustment unit 1204 controls the powder-scooping-and-transferring apparatus to perform the re-scooping operation; when a difference between the second threshold and the scooped-powder amount on the scoop is less than or equal to the fourth threshold, the powder-scooping-and-transferring apparatus is controlled to perform the supplementary-scooping operation until the scooped-powder amount on the scoop is less than or equal to the first threshold and greater than or equal to the second threshold.

Optionally, the control unit 1201 is further configured to control the powder-scooping-and-transferring apparatus to perform a pre-shaking operation with a third amplitude, and acquire a post-pre-shaking weight md recorded by the weighing apparatus when the container base is in contact with the weighing apparatus.

In terms of acquiring the transferred-powder amount ma according to the third weight m3 and the first weight m1, the determination unit 1203 is configured to acquire the transferred-powder amount ma according to the third weight m3 and the post-pre-shaking weight md, where ma=m3−md.

Optionally, in terms of controlling the powder-scooping-and-transferring apparatus to perform the powder-dropping operation at the target container, the control unit 1201 is configured to control the powder-scooping-and-transferring apparatus to move to an opening of the target container, and acquire a second weight m2 recorded by the weighing apparatus when the container base is in contact with the weighing apparatus; and control the powder-scooping-and-transferring apparatus to drop the powder from the opening into the target container.

In terms of acquiring the transferred-powder amount ma according to the third weight m3 and the first weight m1, the determination unit 1203 is configured to acquire the transferred-powder amount ma according to the third weight m3 and the second weight m2, where ma=m3−m2.

Optionally, the powder-scooping-and-transferring apparatus has the scoop. In terms of controlling the powder-scooping-and-transferring apparatus to drop the powder from the opening into the target container, the control unit 1201 is configured to control the scoop to move from the opening of the target container to a powder-dropping position in the target container; and control the scoop to rotate with a pre-set angle, and control the scoop to shake with a fourth amplitude to drop the powder. The pre-set angle is greater than or equal to 90° and less than or equal to 180°.

Optionally, the control unit 1201 is further configured to perform a flattening operation on the powder sample in the source container, before controlling the powder-scooping-and-transferring apparatus to perform the powder-scooping operation at the source container, to make the powder sample in the source container reach a flat state.

Optionally, the powder-scooping-and-transferring apparatus has the scoop. In terms of performing the flattening operation on the powder sample in the source container, the control unit 1201 is configured to control the scoop to reach into the source container and be in contact with or get close to an inner wall of the source container, and control the powder-scooping-and-transferring apparatus to shake the scoop to drive the source container to shake.

Optionally, the powder-scooping system further includes a vibrating-and-flattening apparatus. In terms of performing the flattening operation on the powder sample in the source container, the control unit 1201 is configured to make the vibrating-and-flattening apparatus be in contact with or get close to an outer wall of the source container, and control the vibrating-and-flattening apparatus to start to vibrate the source container.

Optionally, the target container is disposed on the container base in a first direction, the source container is disposed on the container base in a second direction, and the first direction intersects with the second direction.

Optionally, the first direction is a vertical direction, and the opening of the target container is facing upward. In the first direction, an opening of the source container exceeds a bottom of the source container and faces towards the target container, and the opening of the source container exceeds the opening of the target container.

Optionally, the powder-scooping system further includes a moving apparatus, which is connected to the container base and/or the weighing apparatus and is used to drive the container base to be in contact with or separate from the weighing apparatus. In terms of controlling the powder-scooping-and-transferring apparatus to perform the powder-scooping operation at the source container, the control unit 1201 is configured to control the moving apparatus to drive the container base to separate from the weighing apparatus; and control the powder-scooping-and-transferring apparatus to perform the powder-scooping operation at the source container when the container base is not in contact with the weighing apparatus.

In terms of acquiring the first weight m1 recorded by the weighing apparatus when the container base is in contact with the weighing apparatus after the powder-scooping operation is completed, the acquisition unit 1202 is configured to control the moving apparatus to drive the container base to be in contact with the weighing apparatus after the scooping operation is completed; and acquire the first weight m1 recorded by the weighing apparatus when the container base is in contact with the weighing apparatus.

Optionally, the determination unit 1203 is further configured to determine a target number of times for power-scooping.

The control unit 1201 is further configured to control the powder-scooping-and-transferring apparatus to perform n times of rapid powder-scooping operations when the target number of times for powder-scooping operations is greater than a set number.

The determination unit 1203 is further configured to determine a remaining amount of powder to-be-scooped after n times of rapid powder-scooping operations are completed.

The control unit 1201 is further configured to control the powder-scooping-and-transferring apparatus to perform the powder-scooping operation at the source container based on the remaining amount of powder to-be-scooped. A rapid powder-scooping operation includes controlling the powder-scooping-and-transferring apparatus to scoop the powder from the source container and directly drop the scooped-powder into the target container when the container base is not in contact with the weighing apparatus, where n is less than the target number of times for powder-scooping.

The control unit 1201 is further configured to control the powder-scooping-and-transferring apparatus to perform the powder-scooping operation at the source container based on the current amount of powder to-be-scooped when the target number of times for powder-scooping is less than or equal to the set number.

Optionally, the powder-scooping-and-transferring apparatus has the scoop. In terms of determining the target number of times for powder-scooping, the determination unit 1203 is configured to determine the target number of times for powder-scooping according to the transferred-powder amount ma and a target amount of powder to-be-scooped; or determine the target number of times for powder-scooping according to a capacity of the scoop and the target amount of powder to-be-scooped.

Optionally, in terms of determining the remaining amount of powder to-be-scooped, the determination unit 1203 is configured to separate the source container from the container base, and acquires a fourth weight recorded by the weighing apparatus when the container base is in contact with the weighing apparatus; and determine the remaining amount of powder to-be-scooped based on the fourth weight and the target amount of powder to-be-scooped.

The control unit 1201 is further configured to place the source container back on the container base prior to controlling the powder-scooping-and-transferring apparatus to perform the powder-scooping operation at the source container based on the remaining amount of powder to-be-scooped.

The control unit 1201, the acquisition unit 1202, the determination unit 1203, the adjustment unit 1204, and the fine-tuning unit 1205 may be processors in a sample-transferring device.

For specific implementations of the powder-sample-transferring apparatus 1200 illustrated in FIG. 12, reference can be made to method embodiments illustrated in FIG. 3 to FIG. 11, which will not be repeated herein.

In the embodiment of the disclosure, the powder-scooping-and-transferring apparatus can be controlled to perform the powder-scooping operation at the source container, and can be controlled to perform the powder-dropping operation to transfer the powder from the source container to the target container, and can automatically weigh the powder after powder-scooping and powder-dropping. Therefore, automated quantitative transfer of the powder sample is implemented. Compared with manual dispensing, the labor cost is reduced, and the efficiency and accuracy for transferring the powder sample are improved.

Reference can be made to FIG. 13, where FIG. 13 is a schematic structural diagram of a sample-transferring device provided in embodiments of the disclosure. As illustrated in FIG. 13, a sample-transferring device 1300 includes a processor 1301 and a memory 1302, and the processor 1301 and the memory 1302 can be connected to each other through a communication bus 1303. The communication bus 1303 can be a peripheral component interconnect (PCI) bus or an extended industry standard architecture (EISA) bus, etc. The communication bus 1303 can be classified as an address bus, a data bus, a control bus, etc. For ease of representation, only one thick line is used in FIG. 13, but it does not mean that there is only one bus or one type of bus. The memory 1302 is configured to store computer programs, and the computer programs include program instructions. The processor 1301 is configured to invoke the program instructions, and the aforementioned programs includes those for executing some or all of the operations in the methods illustrated in FIG. 3 to FIG. 11.

The memory 1302 may be a read-only memory (ROM) or other types of static storage devices that can store static information and instructions, a random access memory (RAM) or other types of dynamic storage devices that can store information and instructions, and may also be an electrically erasable programmable read-only memory (EEPROM), a compact disc read-only memory (CD-ROM) or other optical disc storage, an optical disc storage (including a compact disc, a laser disc, an optical disc, a digital versatile disc, a Blu-ray disc, etc.), a magnetic disk storage media or other magnetic storage devices, or any other medium that can be used to carry or store desired program code in the form of instructions or data structures and that can be accessed by a computer, but is not limited thereto. The memory can exist independently and be connected to the processor through a bus. The memory can also be integrated with the processor.

The sample-transferring device 1300 may also include a communication module 1304. The communication module 1304 can communicate with a powder-scooping-and-transferring apparatus, a weighing apparatus, etc.

In the embodiment of the disclosure, the powder-scooping-and-transferring apparatus can be controlled to perform a powder-scooping operation at a source container, and can be controlled to perform a powder-dropping operation to transfer powder from the source container to a target container, and automatically weigh the powder after powder-scooping and powder-dropping. Therefore, automated quantitative transfer of powder sample is implemented. Compared with manual dispensing, the labor cost is reduced and the efficiency and accuracy for transferring the powder sample are improved.

A non-transitory computer-readable storage medium is further provided in embodiments of the disclosure. The computer-readable storage medium stores computer programs for electronic data interchange (EDI), and the computer programs cause a computer to execute some or all of the operations of any method for transferring the powder sample as described in the foregoing method embodiments.

It can be noted that, for brevity of description, the foregoing method embodiments are expressed as a combination of a series of actions. However, those of ordinary skill in the art may know that the disclosure is not limited to the described order of actions, because according to the disclosure, some operations can be performed in another order or simultaneously. Secondly, those of ordinary skill in the art may also know that the embodiments described in the description are all preferred embodiments, and the involved actions and modules are not necessarily required in the disclosure.

In the above embodiments, the description of each embodiment has its emphasis. For the parts not described in detail in a certain embodiment, reference can be made to the relevant descriptions of other embodiments.

In the several embodiments provided in the disclosure, it can be understood that the disclosed apparatuses can be implemented in other manners. For example, the apparatus embodiments described above are merely exemplary. For example, the division of the units is merely a logical function division, and there may be other divisions in actual implementation. For example, multiple units or components can be combined or integrated into another system, or some features can be ignored or not implemented. In addition, the displayed or discussed mutual coupling or direct coupling or communication connection may be implemented through some interfaces, and the indirect coupling or communication connection between the apparatuses or units may be implemented in electronic or other manners.

The units described as separate components may or may not be physically separated, and the components displayed as units may or may not be physical units, that is, they may be located at one position, or may be distributed to multiple network units. Some or all of the units can be selected according to actual needs to achieve the purpose of the solution of the embodiment.

In addition, each functional unit in each embodiment of the disclosure can be integrated into one processing unit, or each unit can exist physically independently, or two or more units can be integrated into one unit. The foregoing integrated unit can be implemented in the form of a hardware or in the form of a software program module.

The integrated unit, if implemented in the form of the software program module and sold or used as an independent product, can be stored in a computer-readable memory. Based on such understanding, the technical solution of the disclosure essentially, or the part that contributing to the prior art, or all or part of the technical solutions, can be implemented in the form of a software product. The computer software product is stored in a memory and includes several instructions for instructing a computer device (which can be a personal computer, a sample-transferring device, or a network device, etc.) to execute all or some of the operations of various methods described in embodiments of the disclosure. The foregoing memory includes an USB flash disk, the ROM, the RAM, a mobile hard disk, and other medias that can store program codes like the magnetic disk, the optical disk, etc.

Those of ordinary skill in the art can understand that some or part of the operations in the various methods of the foregoing embodiments can be implemented by programs instructing relevant hardware. The programs can be stored in the computer-readable memory, which may include a flash disk, the ROM, the RAM, the magnetic disk or the optical disk, etc.

The embodiments of the disclosure are described in detail above. In the disclosure, specific examples are used to set forth the principles and implementations of the disclosure. The descriptions of the above embodiments are merely used to help understand the methods and core ideas of the disclosure. Meanwhile, those of ordinary skill in the art can make modifications to the specific implementations and application scopes according to the ideas of the disclosure. In conclusion, the content of the description shall not be construed as a limitation to the disclosure.

What is claimed is:

1. A method for transferring a powder sample, wherein the method is applicable to a powder-scooping system, the powder-scooping system comprises a weighing apparatus, a container base, and a powder-scooping-and-transferring apparatus, the container base is configured to place a source container and a target container, the weighing apparatus is located below the container base and is configured to weigh the container base in a case where the weighing apparatus is in contact with the container base, the powder-scooping-and-transferring apparatus is configured to scoop powder from the source container and transfer scooped powder to the target container; and the method comprises:
controlling the powder-scooping-and-transferring apparatus to perform a powder-scooping operation at the source container;
acquiring a first weight m1 recorded by the weighing apparatus in a case where the container base is in contact with the weighing apparatus, after the powder-scooping operation is completed;
controlling the powder-scooping-and-transferring apparatus to perform a powder-dropping operation at the target container, and acquiring a third weight m3 recorded by the weighing apparatus in a case where the container base is in contact with the weighing apparatus, after the powder-dropping operation is completed; and
acquiring a transferred-powder amount ma according to the third weight m3 and the first weight m1, wherein ma=m3−m1.

2. The method of claim 1, wherein controlling the powder-scooping-and-transferring apparatus to perform the powder-scooping operation at the source container, comprises:
determining a powder-scooping reference position in the source container, and controlling the powder-scooping-and-transferring apparatus to move to the powder-scooping reference position and perform the powder-scooping operation according to a set powder-scooping movement, wherein the set powder-scooping movement is determined based on at least one of an amount of powder in the source container, a current amount of powder to-be-scooped, or a physical property parameter of the powder sample.

3. The method of claim 2, wherein prior to determining the powder-scooping reference position in the source container, the method further comprises:
acquiring an initial weight m0 recorded by the weighing apparatus in a case where the container base is in contact with the weighing apparatus;
wherein determining the powder-scooping reference position in the source container, comprises:
controlling the powder-scooping-and-transferring apparatus to move to a fixed position to perform the powder-scooping operation, and acquiring a weight m0′ recorded by the weighing apparatus;
determining the fixed position as a powder-scooping starting position in the source container in a case where m0′ is less than m0;
controlling the powder-scooping-and-transferring apparatus to move to a next position according to a set step-length and a set direction, in a case where m0′ is equal to m0, to perform the powder-scooping operation until m0′ is less than m0, and determining a position reached by a last movement as the powder-scooping starting position in the source container; and
determining the powder-scooping reference position in the source container based on the powder-scooping starting position;
wherein determining the powder-scooping reference position in the source container based on the powder-scooping starting position, comprises:
acquiring the physical property parameter of the powder sample in the source container;
determining a corresponding powder-scooping offset according to the physical property parameter of the powder sample; and
determining the powder-scooping reference position in the source container based on the powder-scooping starting position and the corresponding powder-scooping offset.

4. The method of claim 2, wherein the powder-scooping system further comprises a visual detection apparatus; and determining the powder-scooping reference position in the source container comprises:
collecting a powder distribution of the powder sample in the source container using the visual detection apparatus;
determining a powder-scooping starting position in the source container according to the powder distribution of the powder sample in the source container; and
determining the powder-scooping reference position in the source container based on the powder-scooping starting position;
wherein the visual detection apparatus comprises a top visual acquisition module and a side visual acquisition module; and collecting the powder distribution of the powder sample in the source container using the visual detection apparatus, comprises:
photographing the source container from top using the top visual acquisition module, and inputting an acquired image in a top view into a first visual model to acquire a powder profile in the top view;
photographing the source container from side using the side visual acquisition module, and inputting an acquired image in a side view into a second visual model to acquire a powder profile in the side view; and
performing a three-dimensional fusion on the powder profile in the top view and the powder profile in the side view to acquire the powder distribution of the powder sample in the source container.

5. The method of claim 1, wherein the powder-scooping-and-transferring apparatus has a scoop; after the powder-scooping operation is completed, the method further comprises:
determining a first scooped-powder amount on the scoop; and
controlling the powder-scooping-and-transferring apparatus to adjust powder on the scoop according to the first scooped-powder amount and a current amount of powder to-be-scooped, to acquire a second scooped-powder amount after adjustment;
wherein controlling the powder-scooping-and-transferring apparatus to perform the powder-dropping operation at the target container, comprises:
controlling the powder-scooping-and-transferring apparatus to perform the powder-dropping operation at the target container based on the second scooped-powder amount.

6. The method of claim 5, wherein the powder-scooping system further comprises a visual detection apparatus; and determining the first scooped-powder amount on the scoop, comprises:
collecting a powder distribution on the scoop with the visual detection apparatus; and
determining the first scooped-powder amount on the scoop based on the powder distribution and a visual prediction model, wherein the visual prediction model is configured to reflect corresponding relationships between different powder distributions and powder amounts.

7. The method of claim 6, wherein prior to controlling the powder-scooping-and-transferring apparatus to perform the powder-scooping operation at the source container, the method further comprises:
acquiring an initial weight m0 recorded by the weighing apparatus in a case where the container base is in contact with the weighing apparatus; and
after acquiring the first weight m1 recorded by the weighing apparatus in a case where the container base is in contact with the weighing apparatus, the method further comprises:
acquiring an actual scooped-powder amount on the scoop according to the initial weight m0 and the first weight m1; and
calculating a deviation between the actual scooped-powder amount and the first scooped-powder amount, and fine-tuning the visual prediction model based on the deviation to acquire a new visual prediction model.

8. The method of claim 5, wherein prior to controlling the powder-scooping-and-transferring apparatus to perform the powder-scooping operation at the source container, the method further comprises:
acquiring an initial weight m0 recorded by the weighing apparatus in a case where the container base is in contact with the weighing apparatus; and
wherein determining the first scooped-powder amount on the scoop, comprises:
acquiring the first scooped-powder amount on the scoop according to the initial weight m0 and the first weight m1.

9. The method of claim 5, wherein controlling the powder-scooping-and-transferring apparatus to adjust the powder on the scoop according to the first scooped-powder amount and the current amount of powder to-be-scooped to acquire the second scooped-powder amount after adjustment, comprises:
remaining the first scooped-powder amount on the scoop unadjusted, and taking the first scooped-powder amount as the second scooped-powder amount, in a case where the first scooped-powder amount is less than or equal to a first threshold and greater than or equal to a second threshold; the first threshold is equal to a sum of the current amount of powder to-be-scooped and an allowable deviation, and the second threshold is equal to a difference between the current amount of powder to-be-scooped and the allowable deviation;
controlling the powder-scooping-and-transferring apparatus to implement a downward adjustment strategy to reduce the powder on the scoop, in a case where the first scooped-powder amount is greater than the first threshold, to acquire the second scooped-powder amount after adjustment; wherein the downward adjustment strategy comprises controlling the powder-scooping-and-transferring apparatus to shake the scoop until a scooped-powder amount on the scoop is less than or equal to the first threshold and greater than or equal to the second threshold; and
controlling the powder-scooping-and-transferring apparatus to implement an upward adjustment strategy to add the powder on the scoop, in a case where the first scooped-powder amount is less than the second threshold, to acquire the second scooped-powder amount after adjustment; wherein the upward adjustment strategy comprises controlling the powder-scooping-and-transferring apparatus to perform a supplementary-scooping operation and/or a re-scooping operation until the scooped-powder amount on the scoop is less than or equal to the first threshold and greater than or equal to the second threshold.

10. The method of claim 9, wherein
controlling the powder-scooping-and-transferring apparatus to implement the downward adjustment strategy to reduce the powder on the scoop, comprises:
controlling the powder-scooping-and-transferring apparatus to shake the scoop with a first amplitude until the scooped-powder amount on the scoop is less than or equal to the first threshold and greater than or equal to the second threshold, in a case where a difference between the first scooped-powder amount and the first threshold is greater than a third threshold; or
controlling the powder-scooping-and-transferring apparatus to shake the scoop with the first amplitude, in a case where the difference between the first scooped-powder amount and the first threshold is greater than the third threshold, and controlling the powder-scooping-and-transferring apparatus to shake the scoop with a second amplitude until the scooped-powder amount on the scoop is less than or equal to the first threshold and greater than or equal to the second threshold, in a case where a difference between the scooped-powder amount on the scoop and the first threshold is greater than 0 and less than or equal to the third threshold; wherein the second amplitude is less than the first amplitude; or
controlling the powder-scooping-and-transferring apparatus to shake the scoop with the second amplitude until the scooped-powder amount on the scoop is less than or equal to the first threshold and greater than or equal to the second threshold, in a case where the difference between the first scooped-powder amount and the first threshold is greater than 0 and less than or equal to the third threshold;
wherein an amplitude for shaking the scoop is determined by the difference between the scooped-powder amount on the scoop and the first threshold, and the difference between the scooped-powder amount on the scoop and the first threshold is positively correlated with the amplitude for shaking the scoop; or
wherein controlling the powder-scooping-and-transferring apparatus to implement the downward adjustment strategy to reduce the powder on the scoop, comprises:
controlling the powder-scooping-and-transferring apparatus to shake the scoop with the first amplitude; and
controlling the powder-scooping-and-transferring apparatus to shake the scoop with the second amplitude until the scooped-powder amount on the scoop is less than or equal to the first threshold and greater than or equal to the second threshold, in a case where a difference between weights recorded by the weighing apparatus at a plurality of adjacent times is less than a set value; wherein the second amplitude is less than the first amplitude.

11. The method of claim 9, wherein controlling the powder-scooping-and-transferring apparatus to implement the upward adjustment strategy to add the powder on the scoop, comprises:
controlling the powder-scooping-and-transferring apparatus to perform the supplementary-scooping operation, in a case where a difference between the second threshold and the first scooped-powder amount is less than or equal to a fourth threshold, until the scooped-powder amount on the scoop is less than or equal to the first threshold and greater than or equal to the second threshold; or
controlling the powder-scooping-and-transferring apparatus to perform the re-scooping operation, in a case where the difference between the second threshold and the first scooped-powder amount is greater than the fourth threshold, until the scooped-powder amount on the scoop is less than or equal to the first threshold and greater than or equal to the second threshold; or
controlling the powder-scooping-and-transferring apparatus to perform the re-scooping operation, in a case where the difference between the second threshold and the first scooped-powder amount is greater than the fourth threshold; and controlling the powder-scooping-and-transferring apparatus to perform the supplementary-scooping operation, in a case where a difference between the second threshold and the scooped-powder amount on the scoop is less than or equal to the fourth threshold, until the scooped-powder amount on the scoop is less than or equal to the first threshold and greater than or equal to the second threshold.

12. The method of claim 1, wherein after acquiring the first weight m1 recorded by the weighing apparatus in a case where the container base is in contact with the weighing apparatus, the method further comprises:
controlling the powder-scooping-and-transferring apparatus to perform a pre-shaking operation with a third amplitude, and acquiring a post-pre-shaking weight md recorded by the weighing apparatus in a case where the container base is in contact with the weighing apparatus;
wherein acquiring the transferred-powder amount ma according to the third weight m3 and the first weight m1, comprises:
acquiring the transferred-powder amount ma according to the third weight m3 and the post-pre-shaking weight md, wherein ma=m3−md.

13. The method of claim 1, wherein the powder-scooping-and-transferring apparatus has a scoop, and controlling the powder-scooping-and-transferring apparatus to perform the powder-dropping operation at the target container, comprises:
controlling the powder-scooping-and-transferring apparatus to move to an opening of the target container, and acquiring a second weight m2 recorded by the weighing apparatus, in a case where the container base is in contact with the weighing apparatus;
controlling the scoop to move from the opening of the target container to a powder-dropping position in the target container; and
controlling the scoop to rotate with a pre-set angle, and controlling the scoop to shake with a fourth amplitude to drop the powder; wherein the pre-set angle is greater than or equal to 90° and less than or equal to 180°;
wherein acquiring the transferred-powder amount ma according to the third weight m3 and the first weight m1, comprises:
acquiring the transferred-powder amount ma according to the third weight m3 and the second weight m2, wherein ma=m3−m2.

14. The method of claim 1, wherein prior to controlling the powder-scooping-and-transferring apparatus to perform the powder-scooping operation at the source container, the method further comprises:
performing a flattening operation on the powder sample in the source container to make the powder sample in the source container reach a flat state; and
wherein the powder-scooping- and transferring apparatus has a scoop; and performing the flattening operation on the powder sample in the source container, comprises:
controlling the scoop to reach into the source container and be in contact with or get close to an inner wall of the source container, and controlling the powder-scooping-and-transferring apparatus to shake the scoop to drive the source container to shake; or
wherein the powder-scooping system further comprises a vibrating-and-flattening apparatus; and performing the flattening operation on the powder sample in the source container, comprises:
making the vibrating-and-flattening apparatus be in contact with or get close to an outer wall of the source container, and controlling the vibrating-and-flattening apparatus to start to vibrate the source container.

15. The method of claim 1, wherein the target container is disposed on the container base in a first direction, the source container is disposed on the container base in a second direction, and the first direction intersects with the second direction; and
the first direction is a vertical direction, and an opening of the target container is facing upward; in the first direction, an opening of the source container exceeds a bottom of the source container and faces towards the target container, and the opening of the source container exceeds the opening of the target container.

16. The method of claim 1, wherein the powder-scooping system further comprises a moving apparatus, the moving apparatus is connected to the container base and/or the weighing apparatus and is configured to drive the container base to be in contact with or separate from the weighing apparatus; and controlling the powder-scooping-and-transferring apparatus to perform the powder-scooping operation at the source container, comprises:
controlling the moving apparatus to drive the container base to separate from the weighing apparatus; and
controlling the powder-scooping-and-transferring apparatus to perform the powder-scooping operation at the source container in a case where the container base is not in contact with the weighing apparatus;
wherein acquiring the first weight m1 recorded by the weighing apparatus in a case where the container base is in contact with the weighing apparatus after the powder-scooping operation is completed, comprises:
controlling the moving apparatus to drive the container base to be in contact with the weighing apparatus after the powder-scooping operation is completed; and
acquiring the first weight m1 recorded by the weighing apparatus in a case where the container base is in contact with the weighing apparatus.

17. The method of claim 1, further comprising:
determining a target number of times for powder-scooping; and
in a case where the target number of times for powder-scooping is greater than a set number of times, controlling the powder-scooping-and-transferring apparatus to perform n times of rapid powder-scooping operations, determining a remaining amount of powder to-be-scooped after n times of rapid powder-scooping operations are completed, executing operations from controlling the powder-scooping-and-transferring apparatus to perform the powder-scooping operation at the source container to acquiring the transferred-powder amount ma according to the third weight m3 and the first weight m1, based on the remaining amount of powder to-be-scooped; and a rapid powder-scooping operation comprises controlling the powder-scooping-and-transferring apparatus to scoop the powder from the source container and directly drop the scooped-powder into the target container in a case where the container base is not in contact with the weighing apparatus, wherein n is less than the target number of times for powder-scooping; and
in a case where the target number of times for powder-scooping is less than or equal to the set number of times, executing the operations from controlling the powder-scooping-and-transferring apparatus to perform the powder-scooping operation at the source container to acquiring the transferred-powder amount ma according to the third weight m3 and the first weight m1, based on a current amount of powder to-be-scooped.

18. The method of claim 17, wherein the powder-scooping-and-transferring apparatus has a scoop; and determining the target number of times for powder-scooping comprises:
determining the target number of times for powder-scooping according to the transferred-powder amount ma and a target amount of powder to-be-scooped; or determining the target number of times for powder-scooping according to a capacity of the scoop and the target amount of powder to-be-scooped; and
determining the remaining amount of powder to-be-scooped comprises:
separating the source container from the container base, and acquiring a fourth weight recorded by the weighing apparatus in a case where the container base is in contact with the weighing apparatus; and
determining the remaining amount of powder to-be-scooped based on the fourth weight and the target amount of powder to-be-scooped; and
wherein prior to executing the operations from controlling the powder-scooping-and-transferring apparatus to perform the powder-scooping operation at the source container to acquiring the transferred-powder amount ma according to the third weight m3 and the first weight m1, based on the remaining amount of powder to-be-scooped, the method further comprises: placing the source container back on the container base.

19. A sample-transferring device, comprising a processor and a memory, wherein the memory is configured to store computer programs, the computer programs comprise program instructions, and the processor is configured to run the program instructions to control a powder-scooping system to perform the following operations; the powder-scooping system comprises a weighing apparatus, a container base, and a powder-scooping-and-transferring apparatus, wherein the container base is configured to place a source container and a target container, the weighing apparatus is located below the container base and is configured to weigh the container base in a case where the weighing apparatus is in contact with the container base, and the powder-scooping-and-transferring apparatus is configured to scoop powder from the source container and transfer scooped powder to the target container; and the operations comprise:
controlling the powder-scooping-and-transferring apparatus to perform a powder-scooping operation at the source container;
acquiring a first weight m1 recorded by the weighing apparatus in a case where the container base is in contact with the weighing apparatus after the powder-scooping operation is completed;
controlling the powder-scooping-and-transferring apparatus to perform a powder-dropping operation at the target container, and acquiring a third weight m3 recorded by the weighing apparatus in a case where the container base is in contact with the weighing apparatus, after the powder-dropping operation is completed; and
acquiring a transferred-powder amount ma according to the third weight m3 and the first weight m1, wherein ma=m3−m1.

20. A non-transitory computer-readable storage medium, configured to store computer programs, and the computer programs comprise program instructions which, when executed by a processor, cause the processor to execute the following:
controlling a powder-scooping-and-transferring apparatus to perform a powder-scooping operation at a source container;
acquiring a first weight m1 recorded by a weighing apparatus in a case where a container base is in contact with the weighing apparatus, after the powder-scooping operation is completed;
controlling the powder-scooping-and-transferring apparatus to perform a powder-dropping operation at a target container, and acquiring a third weight m3 recorded by the weighing apparatus in a case where the container base is in contact with the weighing apparatus, after the powder-dropping operation is completed; and
acquiring a transferred-powder amount ma according to the third weight m3 and the first weight m1, wherein ma=m3−m1.
